(19) United States
(12) Patent Application Publication
(10) Pub. No.: US 2018/0112459 A1
(43) Pub. Date: Apr. 26, 2018

(54) HEAT RAY REFLECTIVE MATERIAL, WINDOW, AND METHOD FOR MANUFACTURING HEAT RAY REFLECTIVE MATERIAL

(71) Applicant: FUJIFILM CORPORATION, Tokyo (JP)

(72) Inventor: Naruhiko AONO, Shizuoka (JP)

(21) Appl. No.: 15/838,389

(22) Filed: Dec. 12, 2017

Related U.S. Application Data
(63) Continuation of application No. PCT/JP2016/068277, filed on Jun. 20, 2016.

(30) Foreign Application Priority Data
Jul. 31, 2015 (JP) 2015-152757

(51) Int. Cl. E06B 9/24; B05D 1/38; B05D 3/10; B05D 5/00; G02B 5/26; B32B 7/12; B32B 27/20

(52) U.S. Cl. CPC E06B 9/24; B05D 1/38; B05D 3/10; B05D 5/00; E06B 2009/2417; B32B 7/12; B32B 27/20; B32B 2307/202; B32B 2307/416; G02B 5/26

(57) ABSTRACT

Provided is a heat ray reflective material including, on a support in the following order from the support side: a conductive particle-containing layer that includes fibrous conductive particles having an average length of 5 μm to 20 μm, and a binder, in which an expansion factor of a thickness before and after the passage of time in a case where 24 hours have elapsed under environmental conditions of a temperature of 63° C. and relative humidity of 50%, is 2.2% or less; and a protective layer that includes a metal oxide derived from a metal alkoxide.

Provided is a heat ray reflective material including, on a support in the following order from the support side: a conductive particle-containing layer that includes the fibrous conductive particles, and a binder having a water absorption rate of 10% or less; and the protective layer.

### CROSS-REFERENCE TO RELATED APPLICATIONS

This application is a continuation application of International Application No. PCT/JP2016/068277, filed Jun. 20, 2016, the disclosure of which is incorporated herein by reference in its entirety. Further, this application claims priority from Japanese Patent Application No. 2015-152757, filed Jul. 31, 2015, the disclosure of which is incorporated herein by reference in its entirety.

### BACKGROUND OF THE INVENTION

### 1. Field of the Invention

The present invention relates to a heat ray reflective material, a window, and a method for manufacturing a heat ray reflective material.

### 2. Description of the Related Art

In recent years, energy saving techniques for reducing an emission amount of carbon dioxide have been studied in various fields. For example, in order to reduce energy consumption such as air conditioning load in buildings such as office buildings or vehicles such as automobiles and railroads, a technique for imparting, to windows used for buildings or vehicles, a function of shielding infrared rays (heat rays) in sunlight or a function of reflecting heat ray radiation from indoors for heat insulation has been studied.

As a material for shielding heat rays, a heat ray-absorbing type material which absorbs heat rays and causes re-radiation of absorbed heat rays and a heat ray reflective type material which reflects heat rays without absorbing the heat rays are known. In addition, from the viewpoint of adaptability to windows of buildings and vehicles, it is desired that the material itself is transparent.

An example of the above-related technique is a glass which shields or reflects heat rays. Specifically, a heat ray-absorbing glass into which ions such as iron, chromium, and titanium are introduced, a heat ray reflective glass on which a metal oxide film is vapor-deposited, a glass formed from indium tin oxide (ITO), tin oxide (ATO), or the like, a heat ray-shielding glass having a heat ray-shielding film in which a noble metal film and a metal oxide film are laminated, and the like are known.

In addition, a heat ray-shielding film having a heat ray reflective layer containing metal nanofibers is disclosed (for example, refer to JP2012-252172A). The heat ray-shielding film disclosed in this document is provided with a heat ray reflective layer containing metal nanofibers on the outermost surface such that heat rays indoors which are reflected thereby do not escape.

In addition to the above, a transparent conductive film containing a metal nanowire surface-treated with a specific colored compound is disclosed as a transparent conductive film not using a metal oxide or a rare metal (for example, refer to JP2015-42717A). An object of the transparent conductive film disclosed in this document is to suppress external light scattering and reduce sheet resistance.

### SUMMARY OF THE INVENTION

A material such as a film for being installed on windows of buildings or vehicles, and the like so as to shield heat rays is usually attached to an installation target while rubbing the surface of the material by using a holding device such as a squeegee in a case of being disposed on the surface of the installation target such as a window glass.

From the viewpoint that an effect of shielding heat rays is more favorably exhibited by such a material, because a layer shielding heat rays is disposed so that the layer is located, for example, on the outermost surface in contact with the indoor atmosphere, it is required that the surface to be rubbed has a resistance (scratch resistance) so that the surface is not damaged by rubbing.

However, in the heat ray-shielding film in which the heat ray reflective layer containing the metal nanofibers is provided on the outermost surface as in JP2012-252172A, the scratch resistance of the surface of the heat ray reflective layer is insufficient.

As a technique for imparting the scratch resistance, there is a method for forming a hard coat layer on a layer shielding heat rays by using a sol-gel method. In the case of the sol-gel method, for example, a solution containing a metal alkoxide is applied to a layer shielding heat rays, but protons contained in the solution permeate the layer shielding heat rays, the layer is dried in a state of the proton permeation, and the protons are confined within the layer. Therefore, the layer shielding heat rays is corroded due to the influence of the protons, and light resistance is impaired.

In a transparent conductive film disclosed in JP2015-42717A, an overcoat layer is further provided on the transparent conductive film on a substrate in some cases, but in a case where the overcoat layer is provided, the influence on the transparent conductive film containing the metal nanowires located on the substrate side as viewed from the overcoat layer is not taken into consideration. Moreover, as disclosed in JP2015-42717A, because the conductive film having a resistance value of 300 Ω/square or less contains the nanowires of metal such as silver, a certain level of heat ray-shielding performance is expected, but the film itself is conductive, and therefore it is considered difficult to maintain radio wave permeability.

An embodiment of the present invention has been made in view of the above circumstances, and provides a heat ray reflective material which has a heat insulation property and has excellent light resistance, scratch resistance, and radio wave permeability; a window; and a method for manufacturing a heat ray reflective material.

The present invention includes the following aspects.

<1>A heat ray reflective material comprising, on a support in the following order from the support side: a conductive particle-containing layer that includes fibrous conductive particles having an average length of 5 μm to 20 μm, and a binder, in which an expansion factor of a thickness before and after the passage of time in a case where 24 hours have elapsed under environmental conditions of a temperature of 63° C. and relative humidity of 50%, is 2.2% or less; and a protective layer that includes a metal oxide derived from a metal alkoxide.

<2>A heat ray reflective material comprising, on a support in the following order from the support side: a conductive particle-containing layer that includes fibrous conductive particles having an average length of 5 μm to 20 μm, and a binder having a water absorption rate of 10% or less; and a protective layer that includes a metal oxide derived from a metal alkoxide.

<3>The heat ray reflective material according to <1>or <2>, in which the binder is at least one selected from polyvinylidene chloride, acrylic polymer, or polyurethane.

<4>The heat ray reflective material according to any one of <1>to <3>, in which a thickness of the protective layer is 0.1 μm to 5 μm.

<5>The heat ray reflective material according to any one of <1>to <4>, in which the fibrous conductive particles are fibrous metal particles.

<6>The heat ray reflective material according to any one of <1>to <5>, in which the metal oxide included in the protective layer is a metal oxide via a metal hydroxide derived from a metal alkoxide and an acid component.

<7>The heat ray reflective material according to any one of <1>to <6>, in which the content of the fibrous conductive particles contained in the conductive particle-containing layer is 0.020 g/m² or more and 0.200 g/m² or less.

<8>The heat ray reflective material according to any one of <1>to <7>, in which a mass ratio of the content of the fibrous conductive particles with respect to the content of the binder is 1/20 or more and 1/10 or less.

<9>A window comprising: a transparent substrate; a pressure sensitive adhesive layer; and the heat ray reflective material according to any one of <1>to <8>.

<10>A method for manufacturing a heat ray reflective material, comprising: a step of applying, on a support, a solution containing fibrous conductive particles having an average length of 5 μm to 20 μm, and a binder having a water absorption rate of 10% or less so as to form a conductive particle-containing layer; a step of adding a metal alkoxide to an acidic aqueous solution and hydrolyzing the metal alkoxide so as to prepare an aqueous composition containing a metal hydroxide; and a step of applying the prepared aqueous composition on the conductive particle-containing layer formed on the support and drying the composition so as to form a protective layer including a metal oxide.

According to one embodiment of the present invention, a heat ray reflective material which has the heat insulation property and has excellent light resistance, scratch resistance, and radio wave permeability; a window; and a method for manufacturing a heat ray reflective material are provided.

### BRIEF DESCRIPTION OF THE DRAWINGS

FIG. 1 is a cross-sectional configuration diagram showing a configuration example of a heat ray reflective material.

FIG. 2 is a cross-sectional configuration diagram showing a configuration example of a window.

### DESCRIPTION OF THE PREFERRED EMBODIMENTS

Hereinafter, a heat ray reflective material of the present disclosure, a window provided with the heat ray reflective material of the present disclosure, and a method for manufacturing a heat ray reflective material will be described in detail.

In the present specification, a numerical value range indicated by using “˜” indicates a range including numerical values described before and after “18 ” as a minimum value and a maximum value, respectively.

Furthermore, in the present specification, “(meth)acryl” means at least one of acrylic and methacrylic, and “(meth)acrylate” means at least one of acrylate and methacrylate.

The heat ray reflective material of the present disclosure is a material having properties of absorbing less heat rays and reflecting heat rays, and contains fibrous conductive particles by which a heat insulation effect can be exhibited.

The form of the heat ray reflective material may be a plate-like material having a film-like or a sheet-like shape.

The term “heat insulation” means a property of reflecting far infrared rays having a wavelength of 5 μm to 20 μm at an average reflectivity of 5% or more. The average reflectivity by which far infrared rays are reflected is preferably 7% or more, more preferably 8% or more, and still more preferably 10% or more.

The average reflectivity of far infrared rays is a value measured by measuring a reflectivity with a spectrophotometer.

The term “window” is the meaning including a window installed in buildings, furniture, or mobile apparatuses such as vehicles or aircraft. The window is a member provided with a transparent substrate such as glass or plastics. Details of the transparent substrate will be described later.

<Heat Ray Reflective Material>

The heat ray reflective material of the present disclosure is a material having at least a support, a conductive particle-containing layer, and a protective layer in this order, and specifically is a material according to a first embodiment or a second embodiment described below. Furthermore, the heat ray reflective material of the first embodiment and the second embodiment may be a material having another layer, if necessary.

A heat ray reflective material according to the first embodiment of the present invention is a material including, in the following order, a support; a conductive particle-containing layer having fibrous conductive particles having an average length of 5 μm to 20 μm, and a binder, in which an expansion factor of a thickness before and after the passage of time is 2.2% or less in a case where 24 hours have elapsed under environmental conditions of a temperature of 63° C. and relative humidity of 50%; and a protective layer having a metal oxide derived from a metal alkoxide.

A heat ray reflective material according to the second embodiment of the present invention is a material including, in the following order, a support; a conductive particle-containing layer having fibrous conductive particles having an average length of 5 μm to 20 μm, and a binder having a water absorption rate of 10% or less; and a protective layer having a metal oxide derived from a metal alkoxide.

In the related art, a material such as a film for shielding heat rays by being installed in a window of a building or a vehicle, and the like is attached to the surface of an installation target such as a window glass while a surface of the material is rubbed with a holding device such as a squeegee or the like. In a case of attaching, for example, the surface of a layer which has a heat ray reflective function and is disposed on the outermost surface for suppressing the absorption of far infrared rays indoors so as to enhance the heat insulation effect, is rubbed. Therefore, it is required that the film has resistance (scratch resistance) by which the rubbed surface is not damaged.

For example, in the heat ray-shielding film as disclosed in the above-described JP2012-252172A, the outermost surface thereof is a heat ray reflective layer containing metal nanofibers, and therefore the scratch resistance cannot be maintained. As a technique for imparting the scratch resistance, there is a method for providing a protective layer on a layer having a heat ray reflective function by using a sol-gel method. However, the sol-gel method is a method in which, for example, a solution containing a metal alkoxide is applied to a layer having a heat ray reflective function so as to form the layer, but protons contained in the solution permeate the layer due to an acid component and the protons are confined within the layer through drying. As a result, the layer having the heat ray reflective function is corroded due to the action of the protons, and light resistance is likely to be impaired.

In view of the above, in the heat ray reflective material of the present disclosure, in the conductive particle-containing layer located between the protective layer formed by the sol-gel method and the support, an expansion factor of a thickness before and after the passage of time is suppressed to be 2.2% or less in a case where 24 hours have elapsed under environmental conditions of a temperature of 63° C. and relative humidity of 50%. In other words, the expansion factor can be adjusted by forming the conductive particle-containing layer using, for example, a specific binder having a low water absorption rate.

By disposing the conductive particle-containing layer which is difficult to expand, that is, for example, whose water absorption rate is suppressed to be low, a deterioration of light resistance in the conductive particle-containing layer is suppressed in a case where the protective layer by the sol-gel method is disposed. Therefore, it is possible to achieve both light resistance and scratch resistance.

In addition, because fibrous conductive particles contained in the conductive particle-containing layer have a length of 5 μm or more by which a heat insulating effect is obtained, and in a case where a length thereof is 20 μm or less, the heat ray reflective material of the present disclosure also has excellent radio wave permeability.

Hereinafter, the heat ray reflective material of the present disclosure will be described mainly with respect to each layer forming each of the first and second embodiments, components of each layer, and the support.

Conductive Particle-Containing Layer

The conductive particle-containing layer according to the first embodiment of the present invention includes fibrous conductive particles having an average length of 5 μm to 20 μm, and a binder, in which an expansion factor of a thickness before and after the passage of time is 2.2% or less in a case where 24 hours have elapsed under environmental conditions of a temperature of 63° C. and relative humidity of 50%. The conductive particle-containing layer may contain other components as necessary. Furthermore, the conductive particle-containing layer in the second embodiment of the present invention includes fibrous conductive particles having an average length of 5 μm to 20 μm, and a binder having a water absorption rate of 10% or less, and may contain other components as necessary.

In the conductive particle-containing layer in the first embodiment, the expansion factor of a thickness before and after the passage of time in a case where time has elapsed under specific conditions is as low as 2.2% or less. Furthermore, the conductive particle-containing layer in the second embodiment includes a binder having a low water absorption rate, and the conductive particle-containing layer is a layer having a low expansion factor similarly to the first embodiment.

The conductive particle-containing layer in the first embodiment may be formed, for example, by using a binder having a low water absorption rate as in the second embodiment, and may be a layer having a low expansion factor by containing a binder and a crosslinking agent so as to provide a crosslinked structure by the binder being crosslinked with the crosslinking agent.

In the conductive particle-containing layer in the present disclosure, the expansion factor of a thickness before and after the passage of time is 2.2% or less in a case where 24 hours have elapsed under environmental conditions of a temperature of 63° C. and relative humidity of 50%. The expansion factor of a thickness being 2.2% or less means that the water-absorbing property of the conductive particle-containing layer is inferior, and in a case where the protective layer is provided in a superposed manner on the conductive particle-containing layer, it is possible to suppress a decrease in the light resistance of the fibrous conductive particles in the conductive particle-containing layer.

From the same viewpoint as described above, with respect to the expansion factor of a thickness, it is preferable as a value becomes lower, and 1.4% or less is more preferable.

The expansion factor of a thickness is a value calculated from Formula 1.

Expansion factor(%)=[(Thickness B after humidity conditioning−dry thickness A)/dry thickness A]×100 Formula 1

[Dry thickness A]: The thickness in a case where the conductive particle-containing layer of the heat ray reflective material is dried at 100° C. for 1 hour and then cut with a microtome, and the cut surface is measured with an atomic force microscope (AFM, Atomic Force Microscope; hereinafter the same applies).

[Thickness B after humidity conditioning]: The thickness in a case where conditions are adjusted to a temperature of 63° C. and relative humidity of 50% for 24 hours, and then the conductive particle containing layer of the heat ray reflective material is cut with the microtome, and the cut surface is measured with the AFM.

The above-described expansion factor of a thickness can be adjusted by the following method.

(1) A method in which a binder having a water absorption rate of 10% or less is used as the binder contained in the conductive particle-containing layer (2) A method for forming a crosslinked structure by using a crosslinking agent in combination and crosslinking the binder with a crosslinking agent

In addition, a surface electrical resistance of the conductive particle-containing layer is preferably 1000 Ω/square or more. In a case where the surface electrical resistance of the conductive particle-containing layer is 1000 Ω/square or more, radio wave permeability can be imparted to the heat ray reflective material.

The surface electrical resistance of the conductive particle-containing layer is preferably 1500 Ω/square or more, more preferably 2000 Ω/square or more, and particularly preferably 3000 Ω/square or more.

The surface electrical resistance is a value measured with a noncontact resistance meter (EC-80, manufactured by NAPSON).

Fibrous Conductive Particles

The conductive particle-containing layer in the first embodiment and the second embodiment contains at least one fibrous conductive particle having an average length of 5 μm to 20 μm. By containing the fibrous conductive particle having a specific average length, it is possible to exhibit the heat insulation effect and maintain the radio wave permeability.

The fibrous conductive particles contained in the conductive particle-containing layer have an average length of 5 μm to 20 μm. In a case where the average length is 5 μm or more, the effect of keeping a heat transfer coefficient low is obtained, and the heat insulation effect is exhibited sufficiently. In addition, by having an average length of 20 μm or less, the radio wave permeability can be maintained.

The average length of the fibrous conductive particles may be within the range of 5 μm to 10 μm.

By containing a relatively small amount of fibrous conductive particles having an average length of 5 μm to 20 μm, the surface electrical resistance of the conductive particle-containing layer can be adjusted to 1000 Ω/square or more, the heat transfer coefficient is suppressed to be low, and therefore it is possible to improve the heat insulation property. Moreover, this is suitable also from the viewpoint of maintaining good radio wave permeability.

The fibrous conductive particles are fibrous particles having conductivity.

The term “fibrous” includes particles having a wire-like shape or a linear-like shape, or a rod-like shape. In addition, the phrase “particles having conductivity” refers to particles in which, in a case where a pellet having a thickness of 0.01 mm or more is produced by filtering the fibrous particles, a resistance value between one end surface and the other end surface of the pellet is 10 Ω or less. The resistance value is a value measured with a tester (YX-361TR, manufactured by Sanwa Electric Instrument Co., Ltd.).

Examples of the fibrous conductive particles include fibrous metal particles (for example, metal nanowires, rod-like metal particles, and the like), carbon nanotubes, fibrous conductive resins, and the like, and any one of a solid structure or a hollow structure may be used. Among these, the fibrous conductive particles are preferably particles having a solid structure. Among the fibrous conductive particles, the fibrous metal particles are preferable, and the metal nanowires are more preferable.

The “metal nanowire” refers to a metal particle having conductivity and having a shape in which a long axis length is longer than a diameter (short axis length) and the short axis length (that is, a length of a cross section orthogonal to a longitudinal direction) is a nano order size.

In the following description, the metal nanowire will be explained as a representative example of the fibrous conductive particles in some cases, but the explanation related to the metal nanowire can be applied as a general explanation of the fibrous conductive particles.

The average length of the fibrous conductive particles refers to an average long axis length described later, and hereinafter the average length of the fibrous conductive particles is also referred to as the “average long axis length”.

The average long axis length of the fibrous conductive particles is preferably about the same as a reflective band width of far infrared rays from the viewpoint of easily reflecting far infrared rays. Therefore, from the viewpoint of easily reflecting far infrared rays having a wavelength of 5 μm to 20 μm, the average long axis length of the fibrous conductive particles is preferably within the range of 5 μm to 20 μm, more preferably within the range of 5 μm to 18 μm, and still more preferably within the range of 5 μm to 15 μm. In a case where the average long axis length of the fibrous conductive particles is 20 μm or less, it is easy to synthesize the fibrous conductive particles without generation of aggregates. In addition, in a case where the average long axis length of the fibrous conductive particles is 5 μm or more, it is suitable for obtaining the heat insulation property.

An average short axis length (average diameter) of the fibrous conductive particles is preferably 150 nm or less. In a case where the average short axis length is 150 nm or less, the heat insulation property is improved and a deterioration of optical characteristics due to light scattering or the like is unlikely to occur.

From the viewpoint of easier formation of a more transparent conductive particle-containing layer, the average short axis length of the fibrous conductive particles (for example, metal nanowire and the like) is preferably within the range of 1 nm to 150 nm.

Furthermore, the average short axis length of the fibrous conductive particles is preferably 100 nm or less, more preferably 60 nm or less, and still preferably 50 nm or less from the viewpoint of ease of handling at the time of production. In addition, the average short axis length is preferably 25 nm or less from the viewpoint that haze is further improved.

In addition, in a case where the average short axis length is 1 nm or more, a conductive particle-containing layer having excellent oxidation resistance and excellent weather fastness can be easily obtained. From the same viewpoint, the average short axis length is more preferably 5 nm or more, still preferably 10 nm or more, and particularly preferably 15 nm or more.

From the viewpoints of a haze value, the oxidation resistance, and the weather fastness, the average short axis length of the fibrous conductive particles is preferably within the range of 1 nm to 100 nm, more preferably within the range of 5 nm to 60 nm, still more preferably within the range of 10 nm to 60 nm, and particularly preferably within the range of 15 nm to 50 nm.

The average short axis length (average diameter) and the average long axis length of the fibrous conductive particles can be obtained by observing a TEM image or an optical microscope image by using, for example, a transmission electron microscope (TEM) and an optical microscope.

Specifically, the average short axis length (average diameter) and the average long axis length of the fibrous conductive particles such as metal nanowires are obtained by measuring a short axis length and a long axis length of 300 randomly selected metal nanowires and obtaining an average value from each measured value, by using a transmission electron microscope (trade name: JEM-2000FX, manufactured by JEOL Ltd.).

As the short axis length in a case where a cross section of the fibrous conductive particles (for example, metal nanowires) in a short axis direction is not circular, a length of a longest point among values measured in the short axis direction is considered as the short axis length. In addition, in a case where the fibrous conductive particles (for example, metal nanowires) are curved, assuming an arc of the curved particles as a circle, a value calculated from a radius and curvature of the circle is considered as the long axis length.

From the viewpoint of the heat insulation property and the radio wave permeability, the fibrous conductive particles preferably have the average short axis length of 150 nm or less and the average long axis length of 5 μm or more and 20 μm or less.

The content of the “fibrous conductive particles (for example, metal nanowires) having the average short axis length (average diameter) of 150 nm or less and the average long axis length is 5 μm or more and 20 μm or less” with respect to the total content of the fibrous conductive particles (for example, metal nanowires) contained in the conductive particle-containing layer is preferably 50% by mass or more, more preferably 60% by mass or more, and still preferably 75% by mass or more in terms of the metal content. Furthermore, the content of the “fibrous conductive particles (for example, metal nanowires) having the average short axis length (average diameter) of 150 nm or less and the average long axis length is 5 μm or more and 20 μm or less” with respect to the total content of the fibrous conductive particles (for example, metal nanowires) contained in the conductive particle-containing layer is preferably 100% by mass or less, more preferably 99% by mass or less, and still more preferably 95% by mass or less in terms of the metal content.

With a content ratio of the fibrous conductive particles having the average short axis length (average diameter) of 150 nm or less and the average long axis length of 5 μm or more and 20 μm or less is 50% by mass or more, good infrared reflectivity is obtained.

A coefficient of variation of the average short axis length (average diameter) of the fibrous conductive particles used for the conductive particle-containing layer is preferably 40% or less, more preferably 35% or less, and still more preferably 30% or less. With the coefficient of variation of 40% or less, a ratio of the fibrous conductive particles that easily reflect far infrared rays at a wavelength of 5 μm to 20 μm increases, which is preferable for improving the transparency and the heat insulation property.

The coefficient of variation of the average short axis length (average diameter) of the fibrous conductive particles is obtained by measuring the short axis length (diameter) of 300 nanowires randomly selected from an image of the transmission electron microscope (TEM) for example, obtaining a standard deviation and an arithmetic mean value of the measured values of the 300 nanowires, and dividing the obtained standard deviation by the arithmetic mean value.

An aspect ratio of the fibrous conductive particles is preferably 10 or more. The aspect ratio is a ratio of the average long axis length to the average short axis length (average long axis length/average short axis length). The aspect ratio can be calculated from the average long axis length and the average short axis length calculated by the above-described method.

In a case where the aspect ratio is 10 or more, a network in which the fibrous conductive particles are in contact with each other is easily formed, and the conductive particle-containing layer having excellent heat insulation property is easily obtained.

The aspect ratio of the fibrous conductive particles may be appropriately selected from a range of 10 or more according to the purpose. The ratio is preferably 10 to 100,000, more preferably 50 to 100,000, and still more preferably 100 to 100,000.

In a case where the aspect ratio is 100,000 or less, in a coating solution in a case of providing the conductive particle-containing layer on the support through coating for example, the formation of aggregates due to entanglement of the fibrous conductive particles with each other is suppressed by which a stable coating solution is obtained easily, and therefore the production of the conductive particle-containing layer becomes easy.

A content ratio of the fibrous conductive particles having an aspect ratio of 10 or more with respect to the total mass of the fibrous conductive particles contained in the conductive particle-containing layer is not particularly limited and is preferably 70% by mass or more, more preferably 75% by mass or more, and still more preferably 80% by mass or more, for example. In addition, the content ratio of the fibrous conductive particles having an aspect ratio of 10 or more with respect to the total mass of the fibrous conductive particles contained in the conductive particle-containing layer is preferably 100% by mass or less, more preferably 99% by mass or less, and still more preferably 95% by mass % or less.

A shape of the fibrous conductive particles can be selected from arbitrary shapes such as a cylindrical shape, a rectangular parallelepiped shape, a columnar shape having a polygonal cross section, and the like. Among these, for applications requiring the transparency, the cylindrical shape or the columnar shape having a polygonal cross section of a pentagon or more (a cross-sectional shape having no acute angle) is preferable.

The cross-sectional shape of the fibrous conductive particles can be confirmed by applying an aqueous dispersion of the fibrous conductive particles such as metal nanowires on a substrate, drying the material to form a coated film, cutting the substrate in parallel with a surface orthogonal to the surface of the substrate, and observing the cut surface with the transmission electron microscope (TEM).

In a case where the fibrous metal particles are used as the fibrous conductive particles, a metal of the fibrous metal particles is not particularly limited and may be any metal. Furthermore, in addition to one metal type, two or more metals may be used in combination, or an alloy may be used. Among these, the fibrous metal particles are preferably fibrous particles of a single metal or a metal compound, and more preferably fibrous particles of a single metal.

As the metal, at least one metal selected from metals of the 4^{th} period, the 5^{th} period, and the 6^{th} period of the periodic table (IUPAC 1991) is preferable, and at least one metal selected from metals of Group 2 to Group 14 is more preferable, and at least one metal selected from metals of Group 2, Group 8, Group 9, Group 10, Group 11, Group 12, Group 13, and Group 14 is still more preferable. As the metal, a case of containing the above-described metal as a main component is particularly preferable. The “main component” means that a ratio to the total amount of the metal is 50 mol % or more.

Examples of the metal include copper, silver, gold, platinum, palladium, nickel, tin, cobalt, rhodium, iridium, iron, ruthenium, osmium, manganese, molybdenum, tungsten, niobium, tantalum, titanium, bismuth, antimony, lead, an alloy containing at least one of these metals, and the like. Among these, copper, silver, gold, platinum, palladium, nickel, tin, cobalt, rhodium, iridium, and an alloy containing at least one of these metals are preferable, palladium, copper, silver, gold, platinum, tin, and an alloy containing at least one of these metals are more preferable, and silver and an alloy containing silver are particularly preferable. The content of silver in the “alloy containing silver” is preferably 50 mol % or more, more preferably 60 mol % or more, still more preferably 80 mol % or more with respect to the total amount of the alloy.

The fibrous conductive particles contained in the conductive particle-containing layer preferably contain silver nanowires from the viewpoint of excellent heat insulation property, and more preferably contain silver having the average short axis length of 1 nm to 150 nm and the average long axis length of 1 μm to 100 μm, and still more preferably contain silver having the average short axis length of 5 nm to 30 nm and the average long axis length of 5 μm to 30 μm.

In a case where the conductive particle-containing layer contains silver nanowires, the content ratio of the silver nanowires with respect to the total mass of the fibrous conductive particles contained in the conductive particle-containing layer is not particularly limited as long as the content ratio does not hinder the effect of the present disclosure. For example, the content ratio is preferably 50% by mass or more and more preferably 80% by mass or more, and it is still more preferable that the total mass of the fibrous conductive particles contained in the conductive particle-containing layer is substantially the silver nanowire. The phrase “is substantially the silver nanowires” means that metal atoms other than silver, which are inevitably mixed may be present.

In a case where another conductive material to be described later is further contained, the content ratio of the fibrous conductive particles (preferably metal nanowires having an aspect ratio of 10 or more) is preferably 50% or more, more preferably 60% or more, and still more preferably 75% or more on a volume basis with respect to the total amount of the conductive materials containing the fibrous conductive particles. In a case where the content ratio of the fibrous conductive particles is 50%, a dense network between the fibrous conductive particles such as metal nanowires is formed and the conductive particle-containing layer having excellent conductivity is easily obtained. The content ratio of the fibrous conductive particles (preferably, metal nanowires having an aspect ratio of 10 or more) is preferably 100% or less, more preferably 99% or less, and still more preferably 95% or less on a volume basis with respect to the total amount of the conductive material containing the fibrous conductive particles.

The content ratio of the fibrous conductive particles such as metal nanowires can be obtained by the following method. For example, in a case where the silver nanowires are contained as the fibrous conductive particles and silver particles are contained as another conductive material, a silver nanowire aqueous dispersion is filtered so as to separate the silver nanowires from other conductive materials. An amount of silver remaining in a filter paper and an amount of silver that has passed through the filter paper are measured by using an inductively coupled plasma (ICP) emission spectrometer, and therefore a ratio of the metal nanowires can be calculated. The aspect ratio of the fibrous conductive particles such as metal nanowires can be calculated by observing the fibrous conductive particles such as metal nanowires remaining in the filter paper with the transmission electron microscope (TEM), measuring the short axis length and the long axis length of 300 fibrous conductive particles, respectively, and then obtaining an average value.

The details of the method for measuring the average short axis length and the average long axis length of the fibrous conductive particles such as metal nanowires are as described above.

The content of the fibrous conductive particles contained in the conductive particle-containing layer is preferably appropriately selected so that resistivity, total light transmittance, and a haze value of the conductive particle-containing layer are within a desired range according to the types and the like of the fibrous conductive particles.

The content of the fibrous conductive particles in the conductive particle-containing layer is preferably 1% by mass to 35% by mass, more preferably 3% by mass to 30% by mass, and still more preferably 5% by mass to 25% by mass with respect to the total mass of the conductive particle-containing layer.

In addition, from the viewpoint of suppressing the resistivity of the conductive particle-containing layer, it is preferable that the amount of the fibrous conductive particles contained in the conductive particle-containing layer is small.

The amount of the fibrous conductive particles per unit area of the conductive particle-containing layer is preferably within the range of 0.020 g/m² to 0.200 g/m², more preferably within the range of 0.030 g/m² to 0.150 g/m², and still more preferably within the range of 0.030 g/m² to 0.050 g/m².

Furthermore, the content ratio (fibrous conductive particles/binder) of the fibrous conductive particles with respect to the binder described later is preferably within the range of 1/20 to 1/3, and more preferably within the range of 1/15 to 1/5. In a case where the ratio of the fibrous conductive particles to the binder is within the above range, it is possible to more effectively improve the heat insulation effect while suppressing the conductivity to be low.

˜Method for Producing Fibrous Conductive Particles˜

The fibrous conductive particles such as metal nanowires are not particularly limited and may be produced by any method.

In a case where the fibrous conductive particles are, for example, silver nanowires, it is preferable to produce the fibrous conductive particles by reducing metal ions in a solvent in which a halogen compound and a dispersant are dissolved. Furthermore, it is preferable to perform desalination treatment by a general method after forming the fibrous conductive particles such as metal nanowires from the viewpoint of dispersibility and temporal stability of the conductive particle-containing layer.

As the method for producing the fibrous conductive particles such as metal nanowires, it is possible to use methods described in JP2009-215594A, JP2009-242880A, JP2009-299162A, JP2010-84173A, JP2010-86714A, and the like.

As the solvent used for producing the fibrous conductive particles such as metal nanowires, hydrophilic solvents are preferable, and examples thereof include water, alcohol-based solvents, ether-based solvents, ketone-based solvents, and the like. These may be used alone, or two or more kinds thereof may be used in combination.

Examples of the alcohol-based solvents include methanol, ethanol, propanol, isopropanol, butanol, ethylene glycol, and the like.

Examples of the ether-based solvents include dioxane, tetrahydrofuran, and the like.

Examples of the ketone-based solvents include acetone and the like.

In a case of heating, a heating temperature is preferably 250° C. or less, more preferably 20° C. or higher and 200° C. or lower, still more preferably 30° C. or higher and 180° C. or lower, and particularly preferably 40° C. or higher and 170° C. or lower. By setting the temperature to 20° C. or higher, the length of the fibrous conductive particles such as metal nanowires to be formed falls within a preferable range in which dispersion stability can be secured. Furthermore, by setting the temperature to 250° C. or lower, an outer circumference of a cross section of the metal nanowire does not have an acute angle and becomes a smooth shape, and therefore coloration due to surface plasmon absorption of the metal particles is suppressed, which is preferable from the viewpoint of the transparency.

If necessary, the temperature may be changed during a particle formation process, and the change in temperature during the process may exhibit the effect of controlling nucleation, suppressing the regeneration of nucleus, and improving monodispersibility by promoting selective growth.

The heat treatment is preferably carried out by adding a reducing agent.

The reducing agent is not particularly limited and can be appropriately selected from those generally used, and examples thereof include metal borohydride, aluminum hydride salt, alkanolamine, aliphatic amine, heterocyclic amine, aromatic amine, aralkyl amine, alcohols, organic acid, reducing sugar, sugar alcohols, sodium sulfite, hydrazine compounds, dextrin, hydroquinone, hydroxylamine, ethylene glycol, glutathione, and the like. Among these, the reducing sugars, the sugar alcohols as derivatives thereof, and ethylene glycol are particularly preferable. For the reducing agent, one may be used alone, or two or more kinds thereof may be used in combination.

Depending on the reducing agent, there are compounds functioning also as a dispersant and a solvent, and these can be preferably used in the same manner.

The production of the fibrous conductive particles such as metal nanowires is preferably carried out by adding a dispersant and a halogen compound or metal halide fine particles.

A timing of adding the dispersant and the halogen compound may be either before or after the addition of the reducing agent and may be either before or after the addition of metal ions or metal halide fine particles, but in order to obtain the fibrous conductive particles with better monodispersibility, it is preferable to add the halogen compound in two or more stages because nucleation and growth can be controlled.

The stage of adding the dispersant is not particularly limited. The dispersant may be added before the preparation of the fibrous conductive particles such as metal nanowires, and the fibrous conductive particles such as metal nanowires may be added under the presence of the dispersant. In addition, the dispersant may be added to control a dispersion state after the preparation of the fibrous conductive particles.

Examples of the dispersant include an amino group-containing compound, a thiol group-containing compound, a sulfide group-containing compound, an amino acid or a derivative thereof, a peptide compound, a polysaccharide, a natural polymer derived from a polysaccharide, a synthetic polymer, a polymer compound such as gel derived from these, and the like. Among these, various polymer compounds used as the dispersant are compounds contained in a polymer described below. For dispersant, one may be used alone, or two or more kinds thereof may be used in combination.

Preferred examples of the polymer suitably used as the dispersant include protective colloidal polymers such as gelatin, polyvinyl alcohol, methyl cellulose, hydroxypropyl cellulose, polyalkylene amine, partially alkyl ester of acrylic acid, polyvinyl pyrrolidone, a copolymer including a polyvinylpyrrolidone structure, and a polymer having a hydrophilic group such as an acrylic acid having an amino group or a thiol group.

In the polymer used as the dispersant, a weight-average molecular weight (Mw) measured by gel permeation chromatography (GPC) is preferably 3000 or more and 300000 or less, and more preferably 5000 or more and 100000 or less.

For examples of the structure of a compound usable as the dispersant, a description of “Pigment's Dictionary” (edited by Seiji Ito, published by Asakura Publishing Co., Ltd., 2000) can be referred to.

It is possible to change a shape of the metal nanowires obtained depending on the types of the dispersant to be used.

The halogen compound is not particularly limited as long as the compound is a compound containing bromine, chlorine or iodine, and can be appropriately selected according to the purpose. For example, a compound which can be used in combination with alkali halides such as sodium bromide, sodium chloride, sodium iodide, potassium iodide, potassium bromide, and potassium chloride, and the following dispersing additives is preferable.

As the halogen compound, there is a halogen compound that functions as a dispersion additive, and the compound can be preferably used similarly.

Silver halide fine particles may be used as a substitute for the halogen compound, or the halogen compound and the silver halide fine particles may be used together.

Alternatively, a single substance having both the functions of the dispersant and the halogen compound may be used. That is, by using the halogen compound having the function as the dispersant, both the functions of the dispersant and the halogen compound are exhibited with one compound.

Examples of the halogen compound having the function of the dispersant include hexadecyl-trimethylammonium bromide (HTAB) containing an amino group and a bromide ion, hexadecyl-trimethylammonium chloride (HTAC) containing an amino group and a chloride ion, dodecyltrimethylammonium bromide containing an amino group and a bromide ion or a chloride ion, dodecyl trimethyl ammonium chloride, stearyl trimethyl ammonium bromide, stearyl trimethyl ammonium chloride, decyl trimethyl ammonium bromide, decyl trimethyl ammonium chloride, dimethyl distearyl ammonium bromide, dimethyl distearyl ammonium chloride, dilauryl dimethyl ammonium bromide, dilauryl dimethyl ammonium chloride, dimethyl dipalmityl ammonium bromide, and dimethyl dipalmityl ammonium chloride.

In the method for producing the metal nanowires, the desalination treatment is preferably performed after the metal nanowires are formed. The desalination treatment after the formation of the metal nanowires can be performed by methods such as ultrafiltration, dialysis, gel filtration, decantation, centrifugation, and the like.

It is preferable that the fibrous conductive particles do not contain inorganic ions such as alkali metal ions, alkaline earth metal ions, and halide ions as much as possible.

Electric conductivity of an aqueous dispersion obtained by dispersing the fibrous conductive particles (for example, metal nanowires) in an aqueous solvent is preferably 1 mS/cm or less, more preferably 0.1 mS/cm or less, and still more preferably 0.05 mS/cm or less.

Viscosity at 25° C. of the aqueous dispersion containing the fibrous conductive particles is preferably 0.5 Mpa·s to 100 Mpa·s, and more preferably 1 Mpa·s to 50 Mpa·s.

The above electric conductivity and the viscosity are measured assuming that a concentration of the fibrous conductive particles in the aqueous dispersion is 0.45% by mass. In a case where a concentration of the fibrous conductive particles in the aqueous dispersion is higher than the above concentration, the measurement is performed by diluting the aqueous dispersion with distilled water. Specifically, the electric conductivity is a value measured using CM-25R manufactured by DKK-TOA CORPORATION, and the viscosity at 25° C. is a value measured at 25° C. using VISCOMETER TVB-10 manufactured by TOKI SANGYO CO., LTD.

Binder

The conductive particle-containing layer in the present disclosure contains at least one binder. The binder functions as a matrix material which maintains the dispersion of the fibrous conductive particles in the conductive particle-containing layer stably and increases the adhesiveness between the support and the conductive particle-containing layer in a case where the conductive particle-containing layer is directly formed on the surface of the support. According to this, durability of the heat ray reflective material is enhanced.

In the conductive particle-containing layer of the heat ray reflective material according to the first embodiment of the present invention, an arbitrary binder can be selected within a range in which the expansion factor of a thickness before and after the passage of time in a case where time has elapsed under certain conditions (temperature 63° C., relative humidity 50%, 24 hours) can be maintained to 2.2% or less.

Examples of the arbitrary binder include a highly aromatic polymer such as an acrylic polymer (for example, polymethacrylic acid, polymethacrylate (for example, poly (methyl methacrylate)), polyacrylate, polyacrylonitrile, and the like), polyvinyl alcohol (PVA), polyester (for example, polyethylene terephthalate (PET), polyethylene naphthalate (PEN), polycarbonate and the like), phenol or cresol-formaldehyde, polystyrene, polyvinyltoluene, polyvinylxylene, polyimide, polyamide, polyamideimide, polyetherimide, polysulfide, polysulfone, polyphenylene, and polyphenyl ether, polyurethane (PU), epoxy, polyolefin (such as polypropylene, polymethylpentene, cyclic olefin, and the like), acrylonitrile/butadiene/styrene copolymer (ABS), cellulose, silicone and other silicone-containing polymer, sesquioxane and polysilane), polyvinylidene chloride (PVDC), polyvinyl chloride (PVC), polyvinyl acetate, polynorbornene, synthetic rubber (for example, ethylene/propylene rubber (EPR), styrene/butadiene rubber (SBR), ethylene/propylene/diene rubber (EPDM)), fluorocarbon polymer (for example, polyvinylidene fluoride, polytetrafluoroethylene (TFE), polyhexafluoropropylene, and the like), fluoro-olefin copolymer, a hydrocarbon olefin (for example, “LUMIFLON” (registered trademark) manufactured by Asahi Glass Co., Ltd.), and amorphous fluorocarbon polymer or copolymer (for example, “CYTOP” (registered trademark) manufactured by Asahi Glass Co., Ltd., “Teflon” (registered trademark) AF manufactured by DuPont). For the binder, one may be used alone, or two or more kinds thereof may be used in combination.

The binder may be crosslinked with a crosslinking agent from the viewpoint of maintaining the expansion factor of a thickness before and after the passage of time in a case where time has elapsed under certain conditions to 2.2% or less.

As the crosslinking agent, a compound capable of forming a chemical bond by free radical, acid or heat, curing the conductive particle-containing layer, and maintaining the expansion factor of a thickness at 2.2% or less can be selected. Examples of the crosslinking agent include melamine compounds substituted with at least one group selected from methylol group, alkoxymethyl group and acyloxymethyl group, guanamine compounds, glycoluril compounds, urea compounds, phenol compounds or ether compounds of phenol, epoxy compounds, oxetane compounds, thioepoxy compounds, isocyanate compounds, azide compounds, compounds having an ethylenically unsaturated group (such as a methacryloyl group or an acryloyl group), and the like. For the crosslinking agent, one may be used alone, or two or more kinds thereof may be used in combination.

As the crosslinking agent, commercially available crosslinking agents may be used. Examples thereof include BURNOCK Series (manufactured by DIC Corporation), DURANATE series (manufactured by Asahi Kasei Corporation), ELASTRON Series (manufactured by DKS Co. Ltd.), TAKENATE Series (manufactured by Mitsui Chemicals, Inc.), and 79XX Series (manufactured by Baxenden Chemicals Limited).

In a case of using the crosslinking agent, the content of the crosslinking agent in the conductive particle-containing layer is preferably 1% by mass to 250% by mass, and more preferably 3% by mass to 200% by mass with respect to the total solid content of the conductive particle-containing layer (or a coating solution for forming the conductive particle containing layer).

As the acrylic polymer among the above-described binder, commercially available products on the market may be used, and examples of the commercially available products include AS-563A, UX-100, UX-110, and the like manufactured by DAICEL FINECHEM LTD.; JURYMER (registered trademark) ET-410 manufactured by Nihon Junyaku Co., Ltd.; AE116, AE119, AE121, AE125, AE134, AE137, AE140, AE173, and the like manufactured by JSR Corporation; ARON A-104 and the like manufactured by TOAGOSEI CO., LTD., and the like.

As the polyvinylidene chloride (PVDC), commercially available products on the market may be used. Examples of the commercially available products include SARAN LATEX Series (for example, SARAN LATEX L549B, SARAN LATEX L536 B, SARAN LATEX L509B, and the like) manufactured by Asahi Kasei Corporation; D-5071 manufactured by DIC Corporation, and the like.

As the polyurethane, commercially available products on the market may be used, and examples of the commercially available products include SUPERFLEX Series (for example, SUPERFLEX E4800, SUPERFLEX 470, SUPERFLEX 420, SUPERFLEX 740, and the like) manufactured by DKS Co. Ltd.; HYDRAN series (for example, AP10, AP20, AP30, AP40, 101H, VONDIC 1320NS, 1610NS, and the like) manufactured by DIC Corporation; D-1000, D-2000, D-6000, D-4000, D-9000, and the like manufactured by Dainichiseika Color & Chemicals Mfg. Co., Ltd.; NS-155X, NS-310A, NS-310X, NS-311X, and the like manufactured by TAKAMATSU OIL & FAT CO., LTD.; ELASTRON manufactured by DKS Co. Ltd.; and the like.

As the polyolefin, commercially available products on the market may be used, and examples of the commercially available products include VESTPLAST W1750 (aqueous polyolefin dispersion) manufactured by Evonik Japan Co., Ltd.; CHEMIPEARL (registered trademark) S120, CHEMIPEARL SA100, CHEMIPEARL V300, and the like manufactured by Mitsui Chemicals, Inc.; Voncoat 2830, Voncoat 2210, Voncoat 2960, and the like manufactured by DIC Corporation; ZAIKTHENE, SEPOLSION G, and the like manufactured by SUMITOMO SEIKA CHEMICALS CO., LTD.; and the like.

As the polyester, commercially available products may be used, and examples of the commercially available products include FINETEX ES650, 611, 675, 850, and the like manufactured by DIC Corporation; WD-size, WMS, and the like manufactured by Eastman Chemical Company; A-110, A-115GE, A-120, A-121, A-124GP, A-124S, A-160P, A-210, A-215GE, A-510, A-513E, A-515GE, A-520, A-610, A-613, A-615GE, A-620, WAC-10, WAC-15, WAC-17XC, WAC-20, S-110, S-110EA, S-111SL, S-120, S-140, S-140A, S-250, S-252G, S-250S, S-320, S-680, DNS-63P, NS-122L, NS-122LX, NS-244LX, NS-140L, NS-141LX, NS-282LX, and the like manufactured by TAKAMATSU OIL & FAT CO., LTD.; ARON MELT PES-1000 series, ARON MELT PES-2000 series, and the like manufactured by TOAGOSEI CO., LTD.; VYLONAL (registered trademark) series (for example, MD-1100, MD-1200, MD-1220, MD-1245, MD-1250, MD-1335, MD-1400, MD-1480, MD-1500, MD-1930, MD-1985, and the like) manufactured by TOYOBO CO., LTD.; SEPOLSION ES manufactured by SUMITOMO SEIKA CHEMICALS CO.,LTD.; and the like.

As the synthetic rubber, commercially available products on the market may be used, and examples of the commercially available products include LACSTAR 7310K, LACSTAR 3307B, LACSTAR 4700H, LACSTAR 7132C, and the like manufactured by DIC Corporation; NIPOL LX416, NIPOL LX410, NIPOL LX430, NIPOL LX435, NIPOL LX110, NIPOL LX415A, NIPOL LX415M, NIPOL LX438C, NIPOL 2507H, NIPOL LX303A, NIPOL LX407BP series, NIPOL V1004, NIPOL MH5055, and the like manufactured by ZEON CORPORATION; and the like.

As the polyvinyl chloride, commercially available products on the market may be used, and examples of the commercially available products include G351, G576, and the like manufactured by ZEON CORPORATION; VINYBLAN series (for example, 240, 270, 277, 375, 386, 609, 550, 601, 602, 630, 660, 671, 683, 680, 680S, 681N, 685R, 277, 380, 381, 410, 430, 432, 860, 863, 865, 867, 900, 900GT, 938, 950, SOLBIN C, SOLBIN CL, SOLBIN CH, SOLBIN CN, SOLBIN C5, SOLBIN M, SOLBIN MF, SOLBIN A, SOLBIN AL, and the like) manufactured by Nissin Chemical co., ltd.; S-LEC A, S-LEC C, S-LEC M, and the like manufactured by SEKISUI CHEMICAL CO., LTD.; DENKA VINYL 1000GKT, DENKA VINYL 1000L, DENKA VINYL 1000CK, DENKA VINYL 1000A, DENKA VINYL 1000LK2, DENKA VINYL 1000AS, DENKA VINYL 1000GS, DENKA VINYL 1000LT3, DENKA VINYL 1000D, DENKA VINYL 1000W, and the like manufactured by Denka Company Limited.; and the like.

As the binder suitable for the conductive particle-containing layer in the heat ray reflective material of the first embodiment, there are one or two or more selected from polyvinylidene chloride, acrylic polymer, or polyurethane, and more preferable binders are acrylic polymer and polyurethane, from the viewpoint of maintaining the expansion factor of the thickness before and after the passage of time in a case where time has elapsed under certain conditions to 2.2% or less, and improving the adhesiveness between the binder and the protective layer.

The conductive particle-containing layer in the heat ray reflective material of the second embodiment of the present invention contains at least one binder having a water absorption rate of 10% or less. The expansion factor of the thickness of the conductive particle-containing layer before and after the passage of time in a case where time has elapsed under certain conditions can be maintained to 2.2% or less, similarly to the conductive particle-containing layer in the first embodiment.

In a case where the water absorption rate of the binder contained in the conductive particle-containing layer is 10% or less, the expansion factor of the thickness before and after the passage of time in a case where time has elapsed under certain conditions can be maintained to 2.2% or less, and therefore it is possible to suppress a deterioration of the weather fastness of the conductive particle-containing layer in a case where the protective layer is formed by the sol-gel method.

The water absorption rate of the binder is a value calculated from Formula 2.

Water absorption rate(%)=[(weight B−weight A)/weight A]×100 Formula 2

[Weight A]: A weight of the binder dried at a temperature of 100° C. for 1 hour

[Weight B]: A weight of the same binder after environmental conditions are adjusted to a temperature of 63° C. and relative humidity of 50% for 24 hours

The water absorption rate of the binder is preferably as low as possible from the viewpoint similar to the above, preferably 5% or less, and more preferably 3% or less.

Examples of the binder having the water absorption rate of 10% or less can be appropriately selected from the above-described binder or the binder having the crosslinked structure by being crosslinked with the crosslinking agent. Among these, as the binder, one or two or more selected from polyvinylidene chloride, acrylic polymer, or polyurethane are preferable from the viewpoint of maintaining the expansion factor of the thickness before and after the passage of time in a case where time has elapsed under certain conditions to 2.2% or less, and improving the adhesiveness between the binder and the protective layer.

From the viewpoints of film properties, heat resistance and solvent resistance, an epoxy compound, an oxetane compound, and a compound having an ethylenically unsaturated group are preferable.

The oxetane compound may be used alone or in a mixture with the epoxy compound. Particularly, a case where the oxetane compound and the epoxy compound are used in combination, is preferable from the viewpoint that a level of the reactivity is high, and the film properties can be improved.

The content of the binder in the conductive particle-containing layer is preferably 65% by mass or more and 99% by mass or less, and more preferably 80% by mass or more and 97% by mass or less with respect to the above-described fibrous conductive particles.

In a case where the content of the binder is 65% by mass or more, radio wave permeability can be easily obtained. Furthermore, a case where the content of the binder is 99% by mass or less, is advantageous from the viewpoint of the heat transfer coefficient.

Sol-Gel Cured Product

The conductive particle-containing layer may contain a sol-gel cured product as a matrix material separately from the above-mentioned binder.

The conductive particle-containing layer preferably contains a sol-gel cured product also having a function as a matrix, and more preferably contains a sol-gel cured product obtained by hydrolyzing and polycondensing an alkoxide compound of an element (b) selected from the group consisting of silicon, titanium, zirconium and aluminum.

The conductive particle-containing layer preferably contains at least a sol-gel cured product obtained by hydrolyzing and polycondensing an alkoxide compound of an element (b) selected from the group consisting of silicon, titanium, zirconium and aluminum, and a metal nanowire containing a metal element (a) and having an average short axis length of 150 nm or less.

The conductive particle-containing layer preferably satisfies at least one of the following conditions (i) and (ii), more preferably satisfies at least the following condition (ii), and particularly preferably satisfies the following conditions (i) and (ii).

(i) A ratio of a substance amount of the element (b) contained in the conductive particle-containing layer to a substance amount of the metal element (a) contained in the conductive particle-containing layer, [(mol number of element (b))/mol number of metal element (a))] is within the range of 0.10/1 to 22/1.

(ii) A ratio of a mass of the alkoxide compound used for forming the sol-gel cured product in the conductive particle-containing layer to a mass of the metal nanowires contained in the conductive particle-containing layer, [(content of alkoxide compound/content of metal nanowires)] is within the range of 0.25/1 to 30/1.

It is preferable to obtain the conductive particle-containing layer in which a ratio of an amount of use of the alkoxide compound to an amount of use of the metal nanowire, that is, a ratio, [(mass of alkoxide compound)/(mass of metal nanowire)] is within 0.25/1 to 30/1. In a case where the mass ratio is 0.25/1 or more, a conductive particle containing layer in which the heat insulation property (considered to be due to excellent conductivity of the fibrous conductive particles) and the transparency are excellent, and all of abrasion resistance, heat resistance, wet heat resistance, and bend-tolerance are excellent, can be obtained. In a case where the mass ratio is 30/1 or less, the conductive particle-containing layer having the excellent conductivity and bend-tolerance can be obtained.

The mass ratio is more preferably within the range of 0.5/1 to 25/1, still more preferably within the range of 1/1 to 20/1, and most preferably within the range of 2/1 to 15/1. By setting the mass ratio within the preferable range, the obtained conductive particle-containing layer has excellent heat insulation property and excellent transparency (visible light transmittance and haze), and has excellent abrasion resistance, heat resistance, and wet heat resistance, and further has excellent bend-tolerance. Therefore, it is possible to stably obtain the heat ray reflective material having suitable physical properties.

In an optimum embodiment, in the conductive particle-containing layer, the ratio of the substance amount of the element (b) to the substance amount of the metal element (a), [(mol number of element (b))/(mol number of metal element (a))] is within the range of 0.10/1 to 22/1. The molar ratio is more preferably within the range of 0.20/1 to 18/1, particularly preferably 0.45/1 to 15/1, more particularly preferably within the range of 0.90/1 to 11/1, and still more particularly preferably within the range of 1.5/1 to 10/1.

In a case where the molar ratio is within the above range, the conductive particle-containing layer can be obtained in a manner of having both the heat insulation property and the transparency, and has excellent wear resistance, heat resistance, wet heat resistance and also has excellent bend-tolerance from the viewpoint of physical properties.

The alkoxide compound that can be used at the time of forming the conductive particle-containing layer is exhausted by hydrolysis and polycondensation, and substantially no alkoxide compound is present in the conductive particle-containing layer, but the element (b) which is silicon or the like derived from the alkoxide compound is contained in the obtained conductive particle-containing layer. By adjusting the amount ratio of the contained element (b) such as silicon and the metal element (a) derived from the metal nanowire to the above range, the conductive particle-containing layer having excellent properties is formed.

A component of the element (b) selected from the group consisting of silicon, titanium, zirconium, and aluminum derived from the alkoxide compound and a component of the metal element (a) derived from the metal nanowire which are in the conductive particle-containing layer can be analyzed by the following method.

That is, by subjecting the conductive particle-containing layer to X-ray photoelectron spectroscopy (Electron Spectroscopy FOR Chemical Analysis, (ESCA)), the substance amount ratio, that is, a value of (mol number of component of element (b))/(mol number of component of metal element (a)) can be calculated. However, in the analysis method by ESCA, because measurement sensitivity varies depending on the element, the obtained value does not necessarily immediately indicate the molar ratio of the elemental components. Therefore, it is possible to prepare a calibration curve using the conductive particle-containing layer whose molar ratio of the elemental components is known in advance, and calculate the substance amount ratio of the actual conductive particle-containing layer from the calibration curve. As the molar ratio of each element in the present specification, a value calculated by the above method is used.

It is preferable that the effects are exhibited, which are that the heat ray reflective material has excellent heat insulation property and transparency, excellent abrasion resistance, heat resistance and wet heat resistance, and also has excellent bend-tolerance. It is considered that these effects are exhibited by the conductive particle-containing layer containing the metal nanowire and containing the matrix which is the sol-gel cured product obtained by hydrolyzing and polycondensing the alkoxide compound. That is, even if a proportion of the matrix contained in the conductive particle-containing layer is within a small range compared to the case of the conductive particle-containing layer containing a general organic polymer resin (for example, a (meth)acrylic resin, a vinyl polymer resin, and the like) as a matrix, because a dense conductive particle-containing layer having less voids and a high level of crosslinking density is formed, it is possible to obtain the heat ray reflective material having excellent abrasion resistance, heat resistance, and wet heat resistance. By satisfying that the molar ratio of the element (b) derived from the alkoxide compound/the metal element (a) derived from the metal nanowire is within the range of 0.10/1 to 22/1, and that, in association with the fact that the range is within 0.10/1 to 22/1, the mass ratio of the alkoxide compound/metal nanowire is within the range of 0.25/1 to 30/1, it is presumed that the above actions are improved in a well-balanced manner, and that the effects that the heat insulation property and the transparency are maintained and the wear resistance, the heat resistance, the wet heat resistance are excellent and also the bend-tolerance is excellent, are obtained.

Other Additives

If necessary, the conductive particle-containing layer may contain additives such as a dispersant, a solvent, a metal antioxidant and other conductive materials.

(Dispersant)

By containing the dispersant, it is possible to disperse while preventing aggregation of the fibrous conductive particles in a coating solution for forming a conductive particle-containing layer described later.

The dispersant is not particularly limited as long as the fibrous conductive particles such as metal nanowires can be dispersed thereby, and can be appropriately selected according to the purpose. For example, a commercially available dispersant can be used as a pigment dispersant. In a case of using the metal nanowire, a polymer dispersant having a property of attaching to the metal nanowire is preferable. Examples of the polymer dispersant include polyvinyl pyrrolidone, BYK series (manufactured by BYK Additives & Instruments), SOLSPERSE series (manufactured by Japan Lubrizol Corporation and the like), AJISPER series (manufactured by AJINOMOTO CO., INC.), and the like. For the dispersant, one may be used alone, or two or more kinds thereof may be used in combination.

The content of the dispersant in the conductive particle-containing layer is preferably from 0.1% by mass to 50% by mass, more preferably from 0.5% by mass to 40% by mass, and still more preferably from 1% by mass to 30% by mass with respect to the total solid content of the conductive particle-containing layer. In a case where the content of the dispersant is 0.1% by mass or more, aggregation of the fibrous conductive particles is effectively suppressed, and in a case where the content of the dispersant is 50% by mass or less, occurrence of coating unevenness at the time of applying a coating solution is suppressed.

(Solvent)

A solvent is a component used for preparing a coating solution containing the fibrous conductive particles and can be appropriately selected according to the purpose. Examples thereof include propylene glycol monomethyl ether, propylene glycol monomethyl ether acetate, ethyl 3-methoxypropionate, methyl 3-methoxypropionate, ethyl lactate, 3-methoxybutanol, water, 1-methoxy-2-propanol, isopropyl acetate, methyl lactate, N-methylpyrrolidone (NMP), γ-butyrolactone (GBL), propylene carbonate, and the like. At least a part of the solvent of a dispersion of the fibrous conductive particles may also be used as the solvent. For solvent, one may be used alone, or two or more kinds thereof may be used in combination.

A concentration of solid contents of the coating solution containing the solvent is preferably within the range of 0.1% by mass to 20% by mass.

(Metal Corrosion Inhibitor)

The conductive particle-containing layer preferably contains a metal corrosion inhibitor for preventing corrosion of a metal in a case where the fibrous metal particles are used as the fibrous conductive particles. The metal corrosion inhibitor is not particularly limited and may be appropriately selected depending on the purpose. For example, a thiol compound or an azole compound is suitable. For the metal corrosion inhibitor, one may be used alone, or two or more kinds thereof may be used in combination.

By containing the metal corrosion inhibitor, an anti-corrosive effect is exhibited, and a deterioration of the heat insulation property and the transparency of the conductive particle-containing layer due to the passage of time can be suppressed. The metal corrosion inhibitor can be applied by being added to the coating solution for forming the conductive particle-containing layer, in a state of being dissolved in a suitable solvent or as a powder.

In a case where the metal corrosion inhibitor is added, a content of the metal corrosion inhibitor in the conductive particle-containing layer is preferably 0.5% by mass to 10% by mass with respect to the content of the fibrous conductive particles.

An average thickness of the conductive particle-containing layer is generally selected in the range of 0.005 μm to 2 μm. For example, by setting the average thickness to 0.001 μm to 0.5 μm, sufficient durability and film hardness can be obtained. In particular, a case where the average thickness is within the range of 0.01 μm to 0.1 μm, is preferable because an allowable range in production can be secured.

The average thickness of the conductive particle-containing layer is calculated as an arithmetic mean value by measuring a thickness of the conductive particle-containing layer by 5 points by direct observation of a cross section of the conductive particle-containing layer using an electron microscope. For example, the thickness of the conductive particle-containing layer can be measured as a level difference between a portion where the conductive particle-containing layer has been formed and a portion where the conductive particle-containing layer has been removed, by using a probe type surface profile measuring device (Dektak (registered trademark) 150, manufactured by Bruker AXS).

In one embodiment of the present invention, by forming the conductive particle-containing layer satisfying at least one of the conditions (i) or (ii) described above, it is preferable that the heat insulation property and the transparency are maintained at a high level, and a high level of strength and durability is realized by the fibrous conductive particles such as metal nanowires being stably fixed due to the sol-gel cured product. For example, it is possible to obtain a conductive particle-containing layer having the abrasion resistance, the heat resistance, the wet heat resistance, and the bend-tolerance, which does not cause practical problems even in a case where the conductive particle-containing layer has a thickness of 0.005 μm to 0.5 μm. Therefore, the heat ray reflective material is suitably used for various purposes. In an embodiment requiring a thin layer, the thickness may be from 0.005 μm to 0.5 μm, is more preferably from 0.007 μm to 0.3 μm, still more preferably from 0.008 μm to 0.2 μm, and most preferably 0.01 μm to 0.1 μm. By making the conductive particle-containing layer thinner in this manner, the transparency of the conductive particle-containing layer can be further improved.

(Other Conductive Materials)

For the conductive particle-containing layer, other conductive materials (for example, conductive fine particles and the like) other than the fibrous conductive particles may be used in combination within a range not impairing the effects of the present disclosure. The conductive materials having a shape other than the fibrous conductive particles such as metal nanowires may have absorption in a visible light region in some cases while not greatly contributing to conductivity in the conductive particle-containing layer. In particular, from the viewpoint that the transparency of the conductive particle-containing layer becomes favorable, it is preferable that the conductive particle is a metal and does not have a shape in which plasmon absorption is strong, such as a spherical shape.

˜Formation of Conductive Particle-Containing Layer˜

A method for forming the conductive particle-containing layer is not particularly limited. It is preferable to use a method capable of forming a layer having a smaller amount of the fibrous conductive particles compared to the total solid content amount in layer formation of the conductive particle-containing layer. A specific preferable range of the amount of the fibrous conductive particles is as described above.

Specifically, as examples of a method for forming the conductive particle-containing layer on a support, a method may be a method in which a dispersion containing the fibrous conductive particles described above is prepared, a solution containing the above-mentioned binder is prepared, and after a solution in which both are mixed is prepared (coating solution for forming the conductive particle-containing layer), the coating solution for forming the conductive particle-containing layer is applied on a support so as to form a coated film, and therefore the conductive particle-containing layer is formed.

In a case where the conductive particle-containing layer is formed by coating, a coating amount of the coating solution for forming the conductive particle-containing layer is preferably an amount within the range of 0.1 g/m² to 1 g/m², and more preferably an amount within the range of 0.15 g/m² to 0.6 g/m² with respect to the coating amount of the total solid content.

In a case where the coating amount of the total solid content is 0.1 g/m² or more, it is easy to form the conductive particle-containing layer having more favorable heat insulation effect. Furthermore, in a case where the coating amount of the total solid content is 1 g/m² or less, the radio wave permeability of the conductive particle-containing layer becomes further excellent.

The coating solution for forming the conductive particle-containing layer may contain an organic solvent, if necessary. By containing the organic solvent, it is possible to form a liquid film having more favorable evenness on the support.

Examples of the organic solvent include ketone-based solvents such as acetone, methyl ethyl ketone, and diethyl ketone, alcohol-based solvents such as methanol, ethanol, 2-propanol, 1-propanol, 1-butanol, and tert-butanol, chlorinated solvents such as chloroform and methylene chloride, aromatic solvents such as benzene and toluene, ester-based solvents such as ethyl acetate, butyl acetate, and isopropyl acetate, ether-based solvents such as diethyl ether, tetrahydrofuran, and dioxane, glycol ether-based solvents such as ethylene glycol monomethyl ether and ethylene glycol dimethyl ether. For the organic solvent, one may be used alone, or two or more kinds thereof may be used in combination. In a case where the coating solution for forming the conductive particle-containing layer contains the organic solvent, a content of the organic solvent is preferably 50% by mass or less and more preferably 30% by mass or less with respect to the total mass of the coating solution.

A method for applying the coating solution to the support will be described later.

After application of the coating solution to the support, curing is performed in some cases. The curing may be performed through either light or heat. The curing through light can be performed by irradiating the coated film with a light source such as a metal halide lamp. The curing through heat can be performed by heating the coated film.

Protective Layer

The heat ray reflective material of the present disclosure further has a protective layer containing a metal oxide derived from a metal alkoxide on the conductive particle-containing layer on the support. By providing the protective layer, the heat ray reflective material has excellent scratch resistance. In addition, since the conductive particle-containing layer described above is disposed as the conductive particle-containing layer positioned between the support and the protective layer, the heat ray reflective material of the present disclosure has a structure in which degradation of the weather fastness of the conductive particle-containing layer caused by forming the protective layer by the sol-gel method is suppressed.

The protective layer in the present disclosure includes a metal oxide derived from a metal alkoxide, and may contain other components as necessary.

The protective layer “containing a metal oxide derived from a metal alkoxide” means the protective layer formed by using a solution containing a metal alkoxide by the sol-gel method.

In the sol-gel method, by forming a gel (jelly solid) through chemical reactions such as hydrolysis and polycondensation, starting from a solution, and removing the solvent left on the inside by heat treatment, it is possible to form a layer.

A metal alkoxide (hereinafter also referred to as an alkoxide compound) is a compound represented by M(OR)ₙ. Here, M represents a metal element, R represents an alkyl group, and n represents the oxidation number of the metal element M. Examples of the metal element represented by M include silicon (Si), tin (Sn), titanium (Ti), aluminum (Al), zirconium (Zr), barium (Ba), magnesium (Mg), zinc (Zn), sodium (Na), and the like.

Preferred examples of the metal alkoxide include an alkoxide compound of the metal element selected from the group consisting of Si, Ti, Zr, and Al. In a case where M═Si, the alkoxide compound is a (mono, di, tri, tetra-)alkoxysilane represented by Si(OR)₄. In addition, examples of the alkoxide compound having another metal element M include Al(O-i-C₃H₇)₃, Ba(OC₂H₅)₂, Mg(OC₂H₅)₂, NaOC₂H₅, Sn(O-i-C₃H₇)₄, Zn(OC₂H₅)₂, Zr(O-i-C₃H₇)₄, Zr(O-t-C₄H₉)₄, and the like. The alkoxide compound may be used alone, or two or more kinds thereof may be used in combination.

In addition, the alkoxysilane includes an epoxy group-containing alkoxysilane having an epoxy group and the like. The protective layer may contain both an epoxy group-containing alkoxysilane and a non-epoxy group-containing alkoxysilane having no epoxy group.

The protective layer in the present disclosure is a layer formed by hydrolyzing and polycondensing an alkoxide compound using the sol-gel method, and for example, the layer may be formed by hydrolyzing and polycondensing an alkoxide compound of a metal element selected from the group consisting of Si, Ti, Zr, and Al.

The formation of the protective layer using the sol-gel method may be carried out by the following method (step of forming the protective layer described later).

First, an aqueous composition is prepared by adding one or two or more metal alkoxides (for example alkoxysilane) to an acidic aqueous solution containing an acid component and sufficiently hydrolyzing the metal alkoxide. In this aqueous composition, the metal alkoxide is hydrolyzed to form a metal hydroxide, and therefore the aqueous composition containing the metal hydroxide is obtained. In addition, if necessary, additives such as metal complexes, transparent particles, and surfactants are added to the aqueous composition. A coated film is formed by coating the aqueous composition on a surface of an object to be coated by using this aqueous composition, and the formed coated film is dried. In the drying process of the coated film, the metal hydroxide in the coated film reacts, and therefore a metal oxide is formed.

In the above manner, a protective layer which is a dry coated film containing the metal oxide derived from the metal alkoxide is formed on the surface of the object to be coated. As described above, the protective layer can contain the metal oxide via the metal hydroxide derived from the metal alkoxide and the acid component.

Hereinafter, components used for preparing the aqueous composition will be described in more detail.

Epoxy Group-Containing Alkoxysilane, Non-Epoxy Group-Containing Alkoxysilane

The aqueous composition used for forming the protective layer may contain an alkoxide compound selected from an epoxy group-containing alkoxysilane and a non-epoxy group-containing alkoxysilane, and preferably contains both the epoxy group-containing alkoxysilane and the non-epoxy group-containing alkoxysilane from the viewpoint of the hardness and the light resistance of the protective layer.

As the alkoxide compound, it is preferable to use a water-soluble or water-dispersible material. The use of the water-soluble or water-dispersible material is also preferable from the viewpoint of reducing environmental pollution due to VOC (volatile organic compounds).

The epoxy group-containing alkoxysilane and the non-epoxy group-containing alkoxysilane each have a hydrolyzable group. The hydrolyzable group is hydrolyzed in an acidic aqueous solution, and thus silanol is produced, and the silanol condenses with each other, whereby an oligomer is formed. In the aqueous composition, some of the epoxy group-containing alkoxysilane and the non-epoxy group-containing alkoxysilane may be hydrolyzed.

A proportion of the epoxy group-containing alkoxysilane with respect to the total alkoxysilane composed of the epoxy group-containing alkoxysilane and the non-epoxy group-containing alkoxysilane is preferably 20% by mass to 100% by mass. A proportion occupied by the epoxy group-containing alkoxysilane is preferably 20% by mass or more, more preferably 25% by mass or more, and still more preferably 30% by mass or more. In addition, the proportion occupied by the epoxy group-containing alkoxysilane is preferably 100% by mass or less, more preferably 90% by mass or less, and still more preferably 85% by mass or less. In a case where the proportion of the epoxy group-containing alkoxysilane with respect to the total alkoxysilane is within the above range, the stability of the aqueous composition can be enhanced and the protective layer having strong alkali resistance can be formed.

The epoxy group-containing alkoxysilane is an alkoxysilane having an epoxy group. The epoxy group-containing alkoxysilane may have one or more epoxy groups in one molecule, and the number of epoxy groups is not particularly limited. In addition to the epoxy group, the epoxy group-containing alkoxysilane may further have a group such as an alkyl group, an amide group, a urethane group, a urea group, an ester group, a hydroxy group, and a carboxyl group.

Examples of the epoxy group-containing alkoxysilane include 2-(3,4-epoxycyclohexyl) ethyltrimethoxysilane, 2-(3,4-epoxycyclohexyl) ethyltriethoxysilane, 2-(3,4-epoxycyclohexyl) ethyltriethoxysilane, 2-(3,4-epoxycyclohexyl) ethylmethyldimethoxysilane, 2-(3,4-epoxycyclohexyl) ethylmethyldiethoxysilane, 3-glycidoxypropyltrimethoxysilane, 3-glycidoxypropyltriethoxysilane, and the like. Examples of commercially available products include KBE-403 (manufactured by Shin-Etsu Chemical Co., Ltd.)

The non-epoxy group-containing alkoxysilane is an alkoxysilane having no epoxy group. The non-epoxy group-containing alkoxysilane may be an alkoxysilane having no epoxy group, and may have a group such as an alkyl group, an amide group, a urethane group, a urea group, an ester group, a hydroxy group, and a carboxyl group.

Examples of the non-epoxy group-containing alkoxysilane include tetraalkoxysilane, trialkoxysilane, and a mixture thereof, and it is preferably tetraalkoxysilane. By providing tetraalkoxysilane, favorable hardness can be obtained in a case where the protective layer is formed.

Tetraalkoxysilane is a tetrafunctional alkoxysilane, and each alkoxy group having 1 to 4 carbon atoms is more preferable. Examples of the tetrafunctional alkoxysilane include tetrafunctional alkoxysilane (hereinafter referred to as “non-epoxy group-containing alkoxysilane” in some cases) such as tetramethoxysilane [Si(OCH₃)₄], tetraethoxysilane [Si(OC₂H₅)₄], tetrapropoxysilane, tetrabutoxysilane, methoxytriethoxysilane, ethoxytrimethoxysilane, methoxytripropoxysilane, ethoxytripropoxysilane, propoxytrimethoxysilane, propoxytriethoxysilane, and dimethoxydiethoxysilane. Among these, tetramethoxysilane and tetraethoxysilane are suitably used. With the number of carbon atoms being 4 or less, a hydrolysis rate of tetraalkoxysilane in a case of being mixed with acidic water does not become excessively slow, and the time required for dissolving until a homogeneous aqueous solution is obtained becomes shorter. According to this, it is possible to increase the production efficiency in a case of manufacturing the protective layer. Examples of commercially available products include KBE-04 (manufactured by Shin-Etsu Chemical Co., Ltd.).

Trialkoxysilane is a trifunctional alkoxysilane and is an alkoxysilane represented by General Formula (1).

RSi(OR¹)₃ (1)

In the formula, R represents an organic group containing no amino group and having 1 to 15 carbon atoms, and R¹ represents an alkyl group having 4 or less carbon atoms.

The trifunctional alkoxysilane represented by General Formula (1) does not contain an amino group as a functional group. That is, this trifunctional alkoxysilane has the organic group R having no amino group. In a case where R has an amino group, in a case of performing hydrolysis by mixing with tetrafunctional alkoxysilane, dehydration condensation is promoted between the produced silanols. Therefore, in a case where the aqueous composition is prepared, the composition tends to be unstable.

R in General Formula (1) may be an organic group having a molecular chain length such that the number of carbon atoms is within the range of 1 to 15, and examples thereof can include a vinyl group, methacryloxypropyl, a methacryloxypropylmethyl group, an acryloxypropyl group, a mercaptopropyl group, a mercaptopropylmethyl group, and the like. With the number of carbon atoms being 15 or less, the flexibility in a case where the protective layer is formed does not become excessively large, and favorable hardness can be obtained. In a case where the number of carbon atoms of R is within the above range, the protective layer with improved brittleness can be obtained. In addition, the adhesiveness to the conductive particle-containing layer can be enhanced.

In addition, examples of the alkyl group having 4 or less carbon atoms represented by R¹ include methyl, an ethyl group, a propyl group, an n-butyl group, a t-butyl group, and the like.

Furthermore, the organic group represented by R may have a heteroatom such as oxygen, nitrogen, sulfur, and the like. With the organic group having a heteroatom, the adhesiveness between the protective layer (or another layer in a case where there is another layer between the protective layer and the conductive particle-containing layer) and the conductive particle-containing layer is further improved.

Examples of the trialkoxysilane include vinyltrimethoxysilane, 3-methacryloxypropyltrimethoxysilane, 3-acryloxypropyltrimethoxysilane, 3-chloropropyltrimethoxysilane, 3-ureidopropyltrimethoxysilane, propyltrimethoxysilane, phenyltrimethoxysilane, vinyltriethoxysilane, 3-methacryloxypropyltriethoxysilane, 3-acryloxypropyltriethoxysilane, 3-chloropropyltriethoxysilane, 3-ureidopropyltriethoxysilane, methyltriethoxysilane, methyl trimethoxysilane, ethyltriethoxysilane, ethyltrimethoxysilane, propyltriethoxysilane, and phenyltriethoxysilane. Among these, methyltriethoxysilane and methyltrimethoxysilane are particularly preferably used. Examples of commercially available products include KBE-13 (manufactured by Shin-Etsu Chemical Co., Ltd.).

Metal Complex (Curing Agent)

The aqueous composition may contain a metal complex (curing agent). As the metal complex, a metal complex having a metal selected from Al, Mg, Mn, Ti, Cu, Co, Zn, Hf, and Zr is preferable, and these metal complexes can also be used in combination.

The metal complex can be easily obtained by reacting a metal alkoxide with a chelating agent. As examples of the chelating agent, β-diketones such as acetylacetone, benzoylacetone, and dibenzoylmethane, β-keto acid esters such as ethyl acetoacetate and ethyl benzoylacetate, and the like can be used, and aluminum chelate is preferable.

Preferred specific examples of the metal complex include aluminum chelate compounds such as ethyl acetoacetate aluminum diisopropylate, aluminum tris(ethyl acetoacetate), alkyl acetoacetate aluminum diisopropylate, aluminum monoacetyl acetate bis(ethyl acetoacetate), and aluminum tris (acetyl acetonate), magnesium chelate compounds such as ethyl acetoacetate magnesium monoisopropylate, magnesium bis(ethyl acetoacetate), alkyl acetoacetate magnesium monoisopropylate, and magnesium bis(acetylacetonate), zirconium tetracetylacetonate, zirconium tributoxyacetylacetonate, zirconium acetylacetonate bis(ethylacetoacetate), manganese acetylacetonate, cobalt acetylacetonate, copper acetylacetonate, titanium acetyl acetonate, titanium oxyacetylacetonate, and the like. Among these, aluminum tris (acetylacetonate), aluminum tris(ethylacetoacetate), magnesium bis(acetylacetonate), magnesium bis(ethylacetoacetate), zirconium tetraacetylacetonate are preferable, and in consideration of storage stability and availability, aluminum tris(acetylacetonate), aluminum tris(ethyl acetoacetate), aluminum bisethylacetoacetate/monoacetylacetonate, which are aluminum chelate complexes, are particularly preferable. Examples of commercially available products include ALUMINUM CHELATE A (W), ALUMINUM CHELATE D, ALUMINUM CHELATE M (manufactured by Kawaken Fine Chemicals Co., Ltd.), and the like.

A proportion occupied by the metal complex is preferably from 20% by mass to 70% by mass, more preferably from 30% by mass to 60% by mass, and still more preferably from 40% by mass to 50% by mass with respect to the total amount of alkoxysilane.

In the present disclosure, in a case where the proportion of the metal complex is 20% by mass or more, a reaction rate of dehydration condensation of silanol can be set to an appropriate rate, and a protective layer having a uniform film thickness and a high level of alkali resistance can be obtained.

Transparent Particles

The aqueous composition may include transparent particles. By including transparent particles, the hardness and lubricity of the protective layer can be improved. The term “transparent” refers to a property in which a proportion of an amount by which the incident light passes is 80% or more. A transparent resin may be used alone, or two or more kinds thereof may be used in combination.

Examples of the transparent particles include polymer particles and metal oxide particles. Specific examples of the polymer particles include particles of acrylic, polystyrene, polyethylene, polyacrylonitrile, ethylene/acrylic acid copolymer, polyurethane, nylon, and the like. Specific examples of the metal oxide particles include particles of silica, alumina, zirconia, and titania, and from the viewpoint of crosslinking with alkoxysilane, silica particles are preferable.

As the silica particles, powdered silica produced by combustion of silicon tetrachloride, and colloidal silica in which silicon dioxide or a hydrate thereof is dispersed in water can be used. In a case where the powdered silica is used, it is possible to add the silica to the aqueous composition by dispersing the silica in water using an ultrasonic disperser or the like. Examples of the colloidal silica are not particularly limited, and include SEAHOSTAR series such as SEAHOSTAR KE-P10 (manufactured by NIPPON SHOKUBAI CO., LTD), SNOWTEX series such as SNOWTEX OZL-35 (manufactured by NISSAN CHEMICAL INDUSTRIES, LTD.), and the like.

It is more preferable that a pH of the colloidal silica at the time of being added to the aqueous composition is adjusted within the range of 2 to 7. In a case where the pH is 2 to 7, the stability of silanol which is a hydrolyzate of alkoxysilane is more favorable compared to a case where the pH thereof is smaller than 2 or larger than 7, and therefore it is possible to suppress an increase in the viscosity of the coating solution caused by the dehydration condensation reaction of silanol being proceeded fast.

A proportion of the transparent particles to the total solid content in the aqueous composition is preferably 30% by volume or more, more preferably 35% by volume or more, and still more preferably 40% by volume or more. In addition, a proportion occupied by the transparent particles is preferably 60% by volume or less, more preferably 55% by volume or less, and still more preferably 50% by volume or less.

Two or more kinds of inorganic particles may be used in combination, and in this case, the total amount of all types used falls within the above range. In a case where a proportion occupied by the inorganic particles is within the above range, the dispersibility of the inorganic particles in the aqueous composition can be enhanced.

Other Additives

A surfactant may be added to the aqueous composition for the purpose of improving the smoothness of the protective layer and reducing the friction of the coated film surface. In addition, the protective layer may be colored by dispersing pigment, dye, fine particles thereof, and the like. Furthermore, for the purpose of improving the weather fastness, an ultraviolet absorber, an antioxidant, and the like may be added.

It is preferable to add a pH adjusting agent to the aqueous composition and adjust the pH so as to be within a desired range. As the pH adjusting agent, an acid (organic acid, inorganic acid) is preferable. Examples of the acid (organic acid, inorganic acid) include nitric acid, oxalic acid, acetic acid, formic acid, hydrochloric acid, and the like. The pH adjusting agent may be added directly or may be added as a solution such as an aqueous solution. An amount of the pH adjusting agent to be used is not particularly limited as long as the pH satisfies a desired range.

In the present disclosure, it is preferable that the pH of the aqueous composition is adjusted to be 2 to 6. As the pH adjusting agent, nitric acid, oxalic acid, acetic acid, formic acid, and hydrochloric acid are preferable, and acetic acid is particularly preferable.

(Surfactant)

Various surfactants may be added to the aqueous composition from the viewpoint of further improving coating properties. As the surfactant, various surfactants such as a fluorine surfactant, a nonionic surfactant, a cationic surfactant, an anionic surfactant, and a silicone surfactant can be used.

Examples of the fluorine surfactant include MEGAFACs (registered trademark) F171, F172, F173, F176, F177, F141, F142, F143, F144, R30, F437, F475, F479, F482, F554, F780, and F781 (manufactured by DIC Corporation), FLUORADs FC430, FC431, and FC171 (manufactured by Sumitomo 3M Limited), SURFLONs (registered trademark) S-382, SC-101, SC-103, SC-104, SC-105, SC1068, SC-381, SC-383, S393, and KH-40 (manufactured by Asahi Glass Co., Ltd.), PF636, PF656, PF6320, PF6520, and PF7002 (manufactured by OMNOVA), and the like.

Specific examples of the nonionic surfactant include glycerol, trimethylolpropane, trimethylolethane, and ethoxylates and propoxylates thereof (for example, glycerol propoxylate, glycerin ethoxylate, and the like), polyoxyethylene lauryl ether, polyoxyethylene stearyl ether, polyoxyethylene oleyl ether, polyoxyethylene octyl phenyl ether, polyoxyethylene nonyl phenyl ether, polyethylene glycol dilaurate, polyethylene glycol distearate, sorbitan fatty acid ester (PLURONICs L10, L31, L61, L62, 10R5, 17R2, and 25R2 and TETRONICs 304, 701, 704, 901, 904, and 150R1 manufactured by BASF SE), PIONINs D-6512, D-6414, D-6112, D-6115, D-6120, D-6131, D-6108-W, D-6112-W, D-6115-W, D-6115-X, and D-6120-X (manufactured by TAKAMATSU OIL & FAT CO., LTD.), SOLSPERSE 20000 (manufactured by Japan Lubrizol Corporation), NAROACTYs (registered trademark) CL-95 and HN-100 (manufactured by Sanyo Chemical Industries, Ltd.), and the like.

Specific examples of the cationic surfactant include phthalocyanine derivatives (trade name: EFKA-745, manufactured by Morishita Chemical Industry Co., Ltd.), organosiloxane polymer KP341 (manufactured by Shin-Etsu Chemical Co., Ltd.), (meth)acrylic acid-based (co) polymer POLYFLOW No. 75, No. 90, and No. 95 (manufactured by KYOEISHA CHEMICAL Co., LTD), W001 (manufactured by Yusho Co., Ltd.), and the like.

Specific examples of the anionic surfactant include W004, W005, and W017 (manufactured by Yusho Co., Ltd.), SANDED (registered trademark) BL (manufactured by Sanyo Chemical Industries, Ltd.), and the like.

Examples of the silicone surfactant include “TORAY SILICONE DC3PA”, “TORAY SILICONE SH7PA”, “TORAY SILICONE DC11PA”, “TORAY SILICONE SH21PA”, “TORAY SILICONE SH28PA”, “TORAY SILICONE SH29PA”, “TORAY SILICONE SH3OPA”, and “TORAY SILICONE SH8400” manufactured by Dow Corning Toray Co., Ltd., “TSF-4440”, “TSF-4300”, “TSF-4445”, “TSF-4460”, and “TSF-4452” manufactured by Momentive Performance Materials Inc., “KP341”, “KF6001”, and “KF6002” manufactured by Shin-Etsu Chemical Co., Ltd., “BYK307”, “BYK323”, and “BYK330” manufactured by manufactured by BYK Additives & Instruments, and the like.

The surfactant may be used alone, or two or more kinds thereof may be used in combination. An addition amount of the surfactant is preferably from 0.001% by mass to 2.0% by mass, and more preferably from 0.005% by mass to 1.0% by mass with respect to the total mass of the aqueous composition.

˜Method for Producing Aqueous Composition and Protective Layer˜

The protective layer is formed by applying the aqueous composition to the surface of the conductive particle-containing layer.

The procedure for preparing the aqueous composition is not particularly limited, but a method is preferable, in which epoxy group-containing alkoxysilane and non-epoxy-containing alkoxysilane are sequentially added, the epoxy group-containing alkoxysilane is hydrolyzed, followed by hydrolysis of the non-epoxy-containing alkoxysilane, and then colloidal silica dispersion and an aluminum chelate complex are sequentially added to the obtained hydrolyzed solution. According to such a method, solubility and storage stability can be enhanced.

For the coating, a known coating device can be used, and details thereof will be described later.

After coating, a step of drying the coating solution is provided. The drying step will be described later in “a step of forming the protective layer” which is described later.

A form of the heat ray reflective material obtained through the drying step may be a roll body wound in a roll shape or a sheet body cut into a desired shape.

The thickness of the protective layer is preferably within the range of 0.1 μm to 5 μm in dry thickness. Because the protective layer is formed by the sol-gel method, it is accompanied by strong shrinkage during the process of layer formation, and curling is likely to occur. Therefore, in a case where the thickness is generally about 0.1 μm to 5 μm, the layer is difficult to follow the window and lenticulation easily occurs in the heat ray reflective material to be attached. However, in the present disclosure, occurrence of curling is suppressed even in a case where the thickness of the protective layer is within the above range where curling is relatively likely to occur, and it is possible to suppress the occurrence of the lenticulation by the layer following the window.

The thickness of the protective layer is more preferably within the range of 0.5 μm to 3 μm from the same viewpoint as described above.

Support

The heat ray reflective material of the present disclosure has a support. As the support, a support having optical transparency can be used and can be appropriately selected from known supports of the related art according to the purpose or the case.

The support is preferably a plate-like material having a visible light transmittance of 70% or more, and more preferably a plate-like material having a visible light transmittance of 80% or more. Furthermore, there are a plate-like material having the above-mentioned visible light transmittance and high transmittance in a near-infrared range, and the like.

The visible light transmittance is a value obtained by a method in accordance with the Japanese Industrial Standards (JIS A 5759:2008).

A shape, structure, size, material, thickness, and the like of the support are not particularly limited and can be appropriately selected according to the purpose. The shape of the support may be, for example, a plate-like shape such as a film shape or a sheet shape. The structure of the support may be a single layer structure or a laminate structure. The size of the support can be appropriately selected according to a desired size of the heat ray reflective material.

The material of the support is not particularly limited and may be appropriately selected according to the purpose. Examples thereof include polyolefin resins such as polyethylene, polypropylene, poly 4-methylpentene-1, and polybutene-1; polyester resins such as polyethylene terephthalate and polyethylene naphthalate; polycarbonate resin, polyvinyl chloride resin, polyphenylene sulfide resin, polyethersulfone resin, polyethylene sulfide resin, polyphenylene ether resin, styrene resin, acrylic resin, polyamide resin, polyimide resin, cellulose resin such as cellulose acetate, and the like.

Among these, polyethylene terephthalate is particularly preferable in terms of the film hardness and the transparency.

The thickness of the support is not particularly limited and may be appropriately selected according to the intended use of the heat ray reflective material, and is generally about 10 μm to 500 μm, and it is preferably thinner from the viewpoint of thinning.

The thickness of the support is preferably 10 μm to 100 μm, more preferably 20 μm to 75 μm, and still more preferably 35 μm to 75 μm.

If the thickness of the support is thick, there is a tendency that defects due to folding of a film during handling are unlikely to occur. In addition, in a case where the thickness of the support is thin, rigidity as a material does not become excessively high and there is a tendency that work becomes easy in a case of attaching to a window of a building or a vehicle as a heat ray reflective material. Furthermore, with the thin support, the visible light transmittance also increases, and a raw material cost tends to be suppressed.

˜Layered Structure of Heat Ray Reflective Material˜

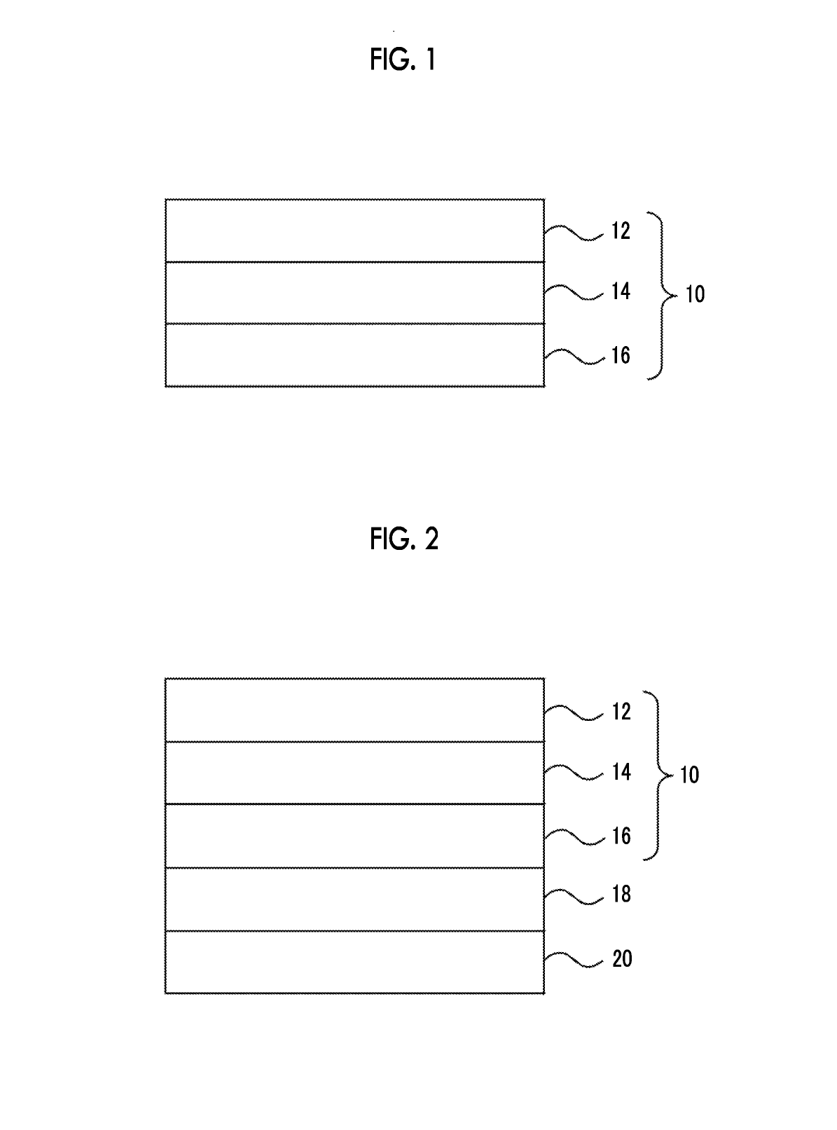

FIG. 1 shows a configuration example of the heat ray reflective material. A laminate structure of the heat ray reflective material of the present disclosure may be a form of a heat ray reflective material 10 in which a protective layer 12, a conductive particle-containing layer 14, and a support 16 are sequentially laminated, as shown in FIG. 1.

In a case of installing the heat ray reflective material on an installation target, from the viewpoint of the heat insulation property, the conductive particle-containing layer is preferably a layer adjacent to an uppermost layer disposed at a position farthest from the installation target or an uppermost layer in the support side.

From the same viewpoint as described above, it is more preferable that the conductive particle-containing layer is the uppermost layer disposed at a position farthest from the window.

˜Method for Manufacturing Heat Ray Reflective Material˜

The heat ray reflective material can be produced by forming the conductive particle-containing layer and the protective layer on the support. In particular, the method therefore may be a method including a step of applying a solution containing fibrous conductive particles having an average length of 5 μm to 20 μm and a binder having a water absorption rate of 10% or less, to a support so as to form a conductive particle-containing layer (hereinafter will be referred to as a step of forming a particle-containing layer), a step of adding a metal alkoxide to an acidic aqueous solution and hydrolyzing the metal alkoxide so as to prepare an aqueous composition containing a metal hydroxide (hereinafter will be referred to as a step of preparing an aqueous composition), and a step of applying the aqueous composition prepared to the conductive particle-containing layer formed on the support and drying the layer so as to form a protective layer containing a metal oxide (hereinafter will be referred to as a step of forming a protective layer).

In the step of forming a particle-containing layer, the solution containing the fibrous conductive particles having an average length of 5 μm to 20 μm and the binder having a water absorption rate of 10% or less, is applied to the support so as to form the conductive particle-containing layer. Details of the fibrous conductive particles, the binder, the support, and the like are as described above, and the method for forming the conductive particle-containing layer in the step of forming a particle-containing layer can be performed by the method described in the “˜Formation of Conductive Particle-Containing Layer˜” described above.

As a method for applying the coating solution to the support, a general coating method can be applied and can be appropriately selected according to the purpose. Examples of the coating method include a roll coating method, a bar coating method, a dip coating method, a spin coating method, a casting method, a die coating method, a blade coating method, a gravure coating method, a curtain coating method, a spray coating method, a doctor coating method, and the like.

In the step of preparing an aqueous composition, in forming the protective layer, the metal alkoxide is added to the acidic aqueous solution and the metal alkoxide is hydrolyzed so as to prepare the aqueous composition containing the metal hydroxide. Details of the metal alkoxide, the acidic aqueous solution, the metal hydroxide, the aqueous composition, and the like are as described above, and the preparation of the aqueous composition in the step of preparing an aqueous composition can be performed by the method described in the “˜Method for Producing Aqueous Composition and Protective Layer˜” described above.

In the step of forming a protective layer, the aqueous composition prepared in the step of preparing an aqueous composition is applied to the conductive particle-containing layer formed on the support, and dried so as to form the protective layer containing the metal oxide. The method for forming the protective layer in the step of forming a protective layer can be performed by the method described in the “˜Method for Producing Aqueous Composition and Protective Layer˜” described above.

For application of the aqueous composition, a known coating device can be used. Examples of the coating device include a spin coater, a roll coater, a bar coater, a curtain coater, and the like.

After coating, a step of drying the coating solution is provided. In the drying step, heat drying is preferably performed. In the heat drying, heating is preferably performed so that a temperature of the coated film becomes 160° C. or higher. The temperature of the coated film is preferably 170° C. or higher, and more preferably 180° C. or higher. In addition, the temperature of the coated film is preferably 220° C. or less, and more preferably 210° C. or less. By setting the heating and drying temperature within the above range, it is possible to satisfactorily cure the coated film, and it is possible to prevent the occurrence of deformation of the protective layer.

The heating time is preferably 10 seconds to 5 minutes.

In a case of producing the heat ray reflective material, the material may be produced in a form of a roll-like shape or a film-like or a sheet-like shape. In a case of producing a film-like or a sheet-like heat ray reflective material, the material may be cut into the film-like or the sheet-like shape after forming the conductive particle-containing layer and the protective layer on the support.

<Window>

The window of the present disclosure has a laminate structure of a transparent substrate/a pressure sensitive adhesive layer/the heat ray reflective material, which includes the transparent substrate, the pressure sensitive adhesive layer, and the above-described heat ray reflective material. It is preferable that the heat ray reflective material is fixed to the transparent substrate via the pressure sensitive adhesive layer with the pressure sensitive adhesive layer disposed on a side having no conductive particle-containing layer and protective layer of the support.

The window includes a window installed in buildings, furniture, or mobile apparatuses such as vehicles or aircraft.

Transparent Substrate

The transparent substrate may be appropriately selected depending on the application, but in general, a plate-like substrate is suitably used.

Examples of the transparent substrate include transparent glass such as white plate glass, blue plate glass, and silica coated blue plate glass; synthetic resins such as polycarbonate, polyether sulfone, polyester, acrylic resin, vinyl chloride resin, aromatic polyamide resin, polyamide imide, and polyimide; metals such as aluminum, copper, nickel, and stainless steel; ceramics, silicon wafers used for semiconductor substrates, and the like. Among these, the transparent substrate is preferably the substrate of the glass or the resin, and more preferably the glass substrate. A glass component is not particularly limited, and for example, transparent glass such as white plate glass, blue plate glass, and silica coated blue plate glass is suitable.

It is preferable that the transparent substrate has a smooth surface, and float glass is particularly preferable.

A thickness of the transparent substrate is preferably 0.5 mm or more, more preferably 1 mm or more, and from the viewpoint of suppressing heat conduction caused by the thickness of the transparent substrate and therefore enhancing warmth, 2 mm or more is particularly preferable.

The visible light transmittance of the heat ray reflective material is preferably 70% or more. The visible light transmittance can be obtained by a method in accordance with the Japanese Industrial Standards (JIS A 5759:2008).

Pressure-Sensitive Adhesive Layer

It is preferable that the pressure sensitive adhesive layer is disposed in contact with the support of the heat ray reflective material.

A pressure sensitive pressure sensitive adhesive component usable for forming the pressure sensitive adhesive layer is not particularly limited and may be appropriately selected according to the purpose. Examples thereof include polyvinyl butyral (PVB) resin, (meth)acrylic resin, styrene/(meth)acrylic resin, urethane resin, polyester resin, silicone resin, and the like. Among these, the (meth)acrylic resin is preferable from the viewpoint of refractive index. The pressure sensitive adhesive component may be used alone, or two or more kinds thereof may be used in combination.

The pressure sensitive adhesive layer can be formed by applying the previously prepared composition.

An antistatic agent, a lubricant, an anti-blocking agent, and the like may be added to the pressure sensitive adhesive layer in addition to the above-described pressure sensitive adhesive component.

A thickness of the pressure sensitive adhesive layer is preferably 0.1 μm to 10 μm.

As the pressure sensitive adhesive layer, commercially available double-sided tape may be used. Examples of the double-sided tape include PANACLEAN PD-S1 (manufactured by PANAC Co., Ltd.).

In a case of disposing the heat ray reflective material on the window, the heat ray reflective material is attached to the indoor side of the window from the viewpoint of the heat insulation effect. In addition, in regard to the conductive particle-containing layer of the heat ray reflective material, a distance from the outermost surface in contact with the indoor atmosphere of the heat ray reflective material is preferably 5 μm or less, more preferably 0.1 μm or more and 5 μm or less, and still more preferably 1 μm or more and 4 μm or less, from the viewpoint of improving heat insulation property, but the distance may vary depending on the thickness. In addition, from the viewpoint of enhancing the heat insulation property, it is preferable that the conductive particle-containing layer has a form of being disposed as the outermost layer on the indoor side or as the layer adjacent to the outermost layer on the support side of the heat ray reflective material, and a form of being disposed as the outermost layer is more preferable.

In a case of disposing the heat ray reflective material on the transparent substrate of the window, the pressure sensitive adhesive layer is provided on the support of the heat ray reflective material by coating or lamination, and then the aqueous solution containing the surfactant (particularly, the anionic surfactant) is sprayed to the surface of the transparent substrate and the surface of the pressure sensitive adhesive layer in advance, and therefore the heat ray reflective material may be attached to the transparent substrate via the pressure sensitive adhesive layer.

After the attachment, a position of the heat ray reflective material can be adjusted on the surface of the transparent substrate until moisture of the sprayed aqueous solution evaporates. After fixing the attachment position of the heat ray reflective material with respect to the transparent substrate, the moisture remaining between the transparent substrate and the heat ray reflective material is swept out from the center towards an end portion by rubbing the surface of the protective layer of the heat ray reflective material with a squeegee or the like. In this manner, the heat ray reflective material can be fixed on the surface of the transparent substrate.

According to the above, the window in which the heat ray reflective material is installed can be obtained.

FIG. 2 shows a configuration example of the window. The structure of the window of the present disclosure may be a form in which a glass plate 20 as a transparent substrate, a pressure sensitive adhesive layer 18, and the heat ray reflective material 10 are laminated in this order, as shown in FIG. 2. The heat ray reflective material is composed of the protective layer 12, the conductive particle-containing layer 14, and the support 16, and is attached to the transparent substrate 20 via the pressure sensitive adhesive layer 18 on the side having no conductive particle-containing layer 14 of the support 16.

Since the window of the present disclosure is formed using the above-described heat ray reflective material, the window has heat insulation property and has excellent light resistance, scratch resistance and radio wave permeability.

### EXAMPLES

Hereinafter, the present invention will be described more specifically with reference to examples, but the present invention is not limited to the following examples unless the examples are beyond their gist.

### Example 1

Preparation of Silver Nanowire Aqueous Dispersion (1) (Average Length of Silver Nanowire 5 μm)

The following additive solutions A, B and C were previously prepared.

(1) Additive Solution A

5.1 g of silver nitrate powder was dissolved in 500 mL (milliliter) of pure water. Thereafter, 1 N (1 mol/L) of aqueous ammonia was added thereto until the solution became transparent. After that, pure water was added so that the total amount became 100 mL.

(2) Additive Solution B

The additive solution B was prepared by dissolving 1 g of glucose powder in 280 mL of pure water.

(3) Additive Solution C

The additive solution C was prepared by dissolving 4 g of hexadecyl-trimethylammonium bromide (HTAB) powder in 220 mL of pure water.

Next, a silver nanowire aqueous dispersion (1) was prepared as follows.

410 mL of pure water was put into a three-neck flask, and while stirring at 20° C., 82.5 mL of the additive solution C and 206 mL of the additive solution B were added through a funnel. To the solution after the addition, 206 mL of the additive solution A was added at a flow rate of 2.0 mL/min and a stirring rotation speed of 800 rpm. After 10 minutes elapsed thereafter, 82.5 mL of the additive solution C was added. Thereafter, an internal temperature was raised to 73° C. at 3° C/min, and then the stirring rotation speed was dropped to 200 rpm, followed by heating for 50 minutes. After heating, the obtained aqueous dispersion was cooled.

Ultrafiltration module SIP1013 (trade name, manufactured by Asahi Kasei Corporation, fraction molecular weight: 6000), a magnetic pump, and a stainless-steel cup were connected by a silicone tube so as to prepare an ultrafiltration device.

The above-described aqueous dispersion after cooling was put into the stainless-steel cup of the ultrafiltration device, and the pump was driven to perform ultrafiltration. At the point where the filtrate from the ultrafiltration module reached 50 mL, 950 mL of distilled water was added to the stainless-steel cup, and the filter residue was washed. The above-described washing was repeated until electric conductivity (measured with CM-25R manufactured by DKK-TOA CORPORATION) reached 50 μS/cm or less, followed by concentration, and therefore 0.84% by mass of the silver nanowire aqueous dispersion (1) was obtained.

An average length (average long axis length) of the silver nanowires contained in the obtained silver nanowire aqueous dispersion (1) was measured by the following method. As a result, it was found that the silver nanowires having an average length of 5 μm were obtained.

Measurement of Average Length of Metal Nanowires

Using a transmission electron microscope (TEM; manufactured by JEOL Ltd., trade name: JEM-2000FX), a TEM image of the metal nanowire was imaged. In the TEM image, 300 metal nanowires were randomly selected, a long axis length of each of the selected metal nanowires was measured, an arithmetic mean value was obtained from the measured value, and therefore an average length (average long axis length) of the metal nanowires was obtained.

Preparation of Silver Nanowire Coating Solution

5.0 parts by mass of a polyolefin aqueous dispersion (VESTOPLAST W1750, solid content: 50% by mass, manufactured by Evonik Japan) as a binder and 42.5 parts by mass of the above-prepared silver nanowire aqueous dispersion (1) were mixed so as to prepare a silver nanowire coating solution.

Formation of Silver Nanowire-Containing Layer

A corona discharge treatment was applied to the surface of a support (PET substrate, A4300 manufactured by TOYOBO CO., LTD.), and the above silver nanowire coating solution was applied to the surface subjected to the corona treatment so that an amount of silver becomes 0.040 g/m² and a coating amount of total solid content becomes 0.280 g/m² by a bar coating method, and therefore a coated film was formed (step of forming a particle-containing layer).

Thereafter, the coated film on the support was dried at 100° C. for 1 minute so as to form a silver nanowire-containing layer having an average thickness of 70 nm as a conductive particle-containing layer.

Preparation of Aqueous Composition 1 for Protective Layer

An aqueous composition for a protective layer was prepared with the following formulation (step of preparing an aqueous composition).

Epoxy group-containing alkoxysilane . . . 8.8 parts by mass

(manufactured by Shin-Etsu Chemical Co., Ltd., KBE-403, 3-glycidoxypropyltriethoxysilane)

Tetraethoxysilane (non-epoxy group-containing alkoxysilane) . . . 2.7 parts by mass

(manufactured by Shin-Etsu Chemical Co., Ltd., KBE-04)

Acetic acid aqueous solution . . . 18.3 parts by mass

(manufactured by Daicel Corporation, 1% by mass aqueous solution of industrial acetic acid)

Aluminum chelate complex . . . 2.6 parts by mass

(manufactured by Kawaken Fine Chemicals Co., Ltd., aluminum chelate D, 76% by mass isopropyl alcohol (IPA) solution)

Inorganic particles (colloidal silica) . . . 23.4 parts by mass

(manufactured by NISSAN CHEMICAL INDUSTRIES, LTD., SNOWTEX OZL-35, solid content concentration: 35% by mass)

Surfactant A . . . 3.3 parts by mass

(manufactured by NOF CORPORATION, 1% by mass diluted solution of LAPIZOL A-90, anionic)

Surfactant B . . . 2.3 parts by mass

(manufactured by Sanyo Chemical Industries, Ltd., 1% by mass diluted solution of NAROACTY CL-95, nonionic)

Water . . . 38.6 parts by mass

Specifically, preparation of the aqueous composition for a protective layer was carried out by the following procedure.

That is, the epoxy group-containing alkoxysilane (KBE-403) was added to 1% by mass acetic acid aqueous solution and sufficiently hydrolyzed, and then the tetraethoxysilane (KBE-04) was added. Subsequently, a required amount of the aluminum chelate complex was added to the epoxy group-containing alkoxysilane, and the inorganic particles (SNOWTEX OZL-35) were further added. Next, the surfactant A and the surfactant B were added, and finally the water was added to prepare the aqueous composition.

Formation of Protective Layer

The surface of the silver nanowire-containing layer was subjected to the corona treatment, and the obtained aqueous composition was applied to the corona-treated surface of the silver nanowire-containing layer using a No. 7 wire bar so that a dry thickness becomes 1 μm, and dried at 115° C. for 2 minutes to laminate a protective layer having a thickness of 1 μm (step of forming a protective layer).

In the manner as above, a heat insulation film having a laminate structure of a support/silver nanowire-containing layer/protective layer was prepared as a heat ray reflective material.

### Examples 2 to 11 and Comparative Example 1

A silver nanowire coating solution was prepared in the same manner as in Example 1 except that the binder (aqueous polyolefin dispersion) used in the preparation of the silver nanowire coating solution in Example 1 was replaced by a binder shown in Table 1. Furthermore, as a heat ray reflective material, a heat insulation film having a laminate structure of a support/silver nanowire-containing layer/protective layer was prepared.

In Example 7, a synthesized product synthesized by the following method was used as a binder.

˜Synthesis of MMA/nBa/AAc Copolymer (Synthetic Product)˜

A dispersion in which methyl methacrylate (MMA), n-butyl acrylate (nBA), and acrylic acid (AAc) were dispersed in water by a mass ratio of 42.5/56.8/0.6 (=MMA/nBa/AAc) by using 2% by mass of a nonionic emulsifier (NEWCOL 506, manufactured by Nippon Nyukazai Co., Ltd.), was fed together with a water-soluble azo-based radical polymerization initiator (VA-086, manufactured by Wako Pure Chemical Industries, Ltd.) to perform emulsion polymerization at 90° C., and therefore an MMA/nBa/AAc copolymer (MMA/nBa/AAc [mass ratio]=42.5/56.8/0.6) was synthesized.

A weight average molecular weight of the synthesized copolymer was 20,000.

The weight average molecular weight (Mw) of the obtained synthetic product was measured by gel permeation chromatography (GPC) under the following conditions. The calibration curve was prepared from 8 samples of “Standard sample TSK standard, polystyrene” manufactured by TOSOH CORPORATION: “F-40”, “F-20”, “F-4”, “F-1”, “A-5000”, “A-2500”, “A-1000”, and “n-propylbenzene”.

<Conditions>

GPC: HLC (registered trademark)-8020GPC (manufactured by TOSOH CORPORATION)

Column: Three columns of TSK gel (registered trademark), Super Multipore HZ-H (manufactured by TOSOH CORPORATION, 4.6 mmID×15 cm)

Eluent: THF (tetrahydrofuran)

Sample concentration: 0.45% by mass

Flow rate: 0.35 ml/min

Sample injection amount: 10 μl

Measuring temperature: 40° C.

Detector: Differential refractometer (RI)

### Examples 12 and 13 and Comparative Examples 2 and 3

A silver nanowire coating solution was prepared in the same manner as in Example 5 except that in Example 5, the silver nanowire aqueous dispersion (1) was replaced by any one of silver nanowire aqueous dispersions (2) to (5) shown in Table 1. Furthermore, a heat insulation film having a laminate structure of a support/silver nanowire-containing layer/protective layer was prepared as a heat ray reflective material.

The silver nanowire aqueous dispersions (2) to (5) were prepared as follows.

Preparation of Silver Nanowire Aqueous Dispersion (2) (Silver Nanowire Average Length 3 μm)

In the preparation of the silver nanowire aqueous dispersion (1), the internal temperature was raised to 73° C. and the heating time after dropping the stirring rotation speed to 200 rpm was set to 30 minutes, therefore the silver nanowire aqueous dispersion (2) having an average length of 3 μm was obtained.

Preparation of Silver Nanowire Aqueous Dispersion (3) (Silver Nanowire Average Length 10 μm)

In the preparation of the silver nanowire aqueous dispersion (1), the internal temperature was raised to 73° C. and the heating time after dropping the stirring rotation speed to 200 rpm was set to 1 hour and 35 minutes, and therefore the silver nanowire silver nanowire (3) having an average length of 10 μm was obtained.

Preparation of Silver Nanowire Aqueous Dispersion (4) (Silver Nanowire Average Length 20 μm)

In the preparation of the silver nanowire aqueous dispersion (1), the internal temperature was raised to 73° C. and the heating time after dropping the stirring rotation speed to 200 rpm was set to 3 hours and 10 minutes, and therefore the silver nanowire silver nanowire (4) having an average length of 20 μm was obtained.

Preparation of Silver Nanowire Aqueous Dispersion (5) (Silver Nanowire Average Length 23 μm)

In the preparation of the silver nanowire aqueous dispersion (1), the internal temperature was raised to 73° C. and the heating time after dropping the stirring rotation speed to 200 rpm was set to 3 hours and 40 minutes, and therefore the silver nanowire silver nanowire (5) having an average length of 23 μm was obtained.

### Examples 14 to 16

A silver nanowire coating solution was prepared in the same manner as in Example 5, except that in Example 5, the dry thickness of the protective layer was changed from 1 μm to a thickness shown in Table 1. Furthermore, a heat insulation film having a laminate structure of a support/silver nanowire-containing layer/protective layer was prepared as a heat ray reflective material.

### Comparative Example 4

A silver nanowire coating solution was prepared in the same manner as in Example 1 except that in Example 1, the binder (aqueous polyolefin dispersion) used in the preparation of the silver nanowire coating solution was replaced by a polyvinyl alcohol aqueous solution (POVAL 117 manufactured by KURARAY CO., LTD.; PVA) and no protective layer was formed. Furthermore, as a heat ray reflective material, a heat insulation film having a laminate structure of a support/silver nanowire-containing layer/protective layer was prepared.

### Comparative Example 5

A silver nanowire coating solution was prepared in the same manner as in Example 1 except that in Example 1, the binder (aqueous polyolefin dispersion) used in the preparation of the silver nanowire coating solution was replaced by a polyvinyl alcohol aqueous solution (POVAL 117 manufactured by KURARAY CO., LTD.; PVA). Furthermore, as a heat ray reflective material, a heat insulation film having a laminate structure of a support/silver nanowire-containing layer/protective layer was prepared.

### Comparative Example 6

A silver nanowire coating solution was prepared in the same manner as in Example 1 except that in Example 1, the binder (aqueous polyolefin dispersion) used in the preparation of the silver nanowire coating solution was replaced by a polyvinyl alcohol aqueous solution (POVAL 117 manufactured by KURARAY CO., LTD.; PVA) and the aqueous composition used for forming the protective layer was replaced by the following aqueous composition 2 for a protective layer. Furthermore, as a heat ray reflective material, a heat insulation film having a laminate structure of a support/silver nanowire-containing layer/protective layer was prepared.

Preparation of Aqueous Composition 2 for Protective Layer

Each component having the following composition was mixed and stirred for 60 minutes to prepare the aqueous composition 2 for a protective layer.

<Composition>

Dipropylene glycol diacrylate (DPGDA) . . . 7.0 parts by mass

(Bifunctional polymerizable monomer)

Phenoxyethyl acrylate (PEA) . . . 3.0 parts by mass

(Monofunctional polymerizable monomer)

Trimethylolpropane triacrylate (TMPTA) . . . 10.0 parts by mass

(Trifunctional polymerizable monomer)

Polymerization initiator (IRGACURE 184, manufactured by BASF SE) . . . 1.0 part by mass

Solvent (propylene glycol monomethyl ether) . . . 200 parts by mass

### Comparative Example 7

A silver nanowire coating solution was prepared in the same manner as in Example 1 except that in Example 1, the silver nanowire aqueous dispersion (1) was replaced by the above-described silver nanowire aqueous dispersion (5) and the binder (aqueous polyolefin dispersion) used in the preparation of the silver nanowire coating solution was replaced by a polyvinyl alcohol aqueous solution (POVAL 117 manufactured by KURARAY CO., LTD.; PVA). Furthermore, as a heat ray reflective material, a heat insulation film having a laminate structure of a support/silver nanowire-containing layer/protective layer was prepared.

### Comparative Example 8

A silver nanowire coating solution was prepared in the same manner as in Example 1 except that in Example 1, the binder (aqueous polyolefin dispersion) used in the preparation of the silver nanowire coating solution was replaced by an eval aqueous solution (EVAL L171B manufactured by KURARAY CO., LTD.; EVOH) and the aqueous composition used for forming the protective layer was replaced by the aqueous composition 2 for a protective layer prepared in Comparative Example 6. Furthermore, as a heat ray reflective material, a heat insulation film having a laminate structure of a support/silver nanowire-containing layer/protective layer was prepared.

### Comparative Example 9

A silver nanowire coating solution was prepared in the same manner as in Example 1 except that in Example 1, the silver nanowire aqueous dispersion (1) was replaced by the above-described silver nanowire aqueous dispersion (5) and the binder (aqueous polyolefin dispersion) used in the preparation of the silver nanowire coating solution was replaced by an eval aqueous solution (EVAL L171B manufactured by KURARAY CO., LTD.; EVOH). Furthermore, as a heat ray reflective material, a heat insulation film having a laminate structure of a support/silver nanowire-containing layer/protective layer was prepared.

### Comparative Example 10

A silver nanowire coating solution was prepared in the same manner as in Example 1 except that in Example 1, the binder (aqueous polyolefin dispersion) used in the preparation of the silver nanowire coating solution was replaced by an eval aqueous solution (EVAL L171B manufactured by KURARAY CO., LTD.; EVOH). Furthermore, as a heat ray reflective material, a heat insulation film having a laminate structure of a support/silver nanowire-containing layer/protective layer was prepared.

(Evaluation)

Each of the heat insulation films produced in the above examples and comparative examples was subjected to the following measurement and evaluation. The results of the measurement and evaluation are shown in Table 1 below.

1. Water Absorption Rate

(1) A weight A (mg) of the binder dried at a temperaturue of 100° C. for 1 hour was measured.

(2) The same binder as above was conditioned for 24 hours under an environment at a temperature of 63° C. and relative humidity of 50%, and a weight B (mg) after humidity conditioning was measured.

(3) A water absorption rate (%) was calculated from Formula 2 using the measurement values obtained from the above.

Water absorption rate(%)=[(weight B−weight A)/weight A]×100 Formula 2

2. Expansion Factor of Thickness

(1) After drying the silver nanowire-containing layer at 100° C. for 1 hour, the layer was cut with a microtome and the cut surface was measured with an atomic force microscope (AFM) to measure a dry thickness A of the silver nanowire-containing layer.

(2) The same silver nanowire-containing layer as above was conditioned at a temperature of 63° C. and relative humidity of 50% for 24 hours, the layer was cut with a microtome, the cut surface was measured by AFM so as to measure a thickness B of the silver nanowire-containing layer.

(3) Using the measured values obtained above, an expansion factor (%) of the thickness was calculated from Formula 1.

Expansion factor(%)=[thickness B after humidity conditioning−dry thickness A)/dry thickness A]×100 Formula 1

3. Thickness of Protective Layer

The protective layer was cut with a microtome, the cut surface was observed with a scanning electron microscope (SEM), and a thickness was obtained from the SEM image.

4. Average Length

(1) The silver nanowire-containing layer was immersed in a binder-soluble solvent (water, tetrahydrofuran, methyl ethyl ketone, or the like) to extract silver nanowires.

(2) By magnification observation using the transmission electron microscope (TEM: manufactured by JEOL Ltd., trade name: JEM-2000FX), 300 silver nanowires were randomly selected from the silver nanowires which were magnified and observed, and a long axis length of the selected silver nanowire was measured. An average value was further obtained as an average length (average long axis length) of the silver nanowire.

5. Radio Wave Permeability

In accordance with the KEC measurement method from the Kansai Electronic Industrial Promotion Center (KEC), a radio wave attenuation rate [dB] at 0.1 MHz and 2 GHz of each heat insulation film of the examples and comparative examples was calculated by Formula 3, and radio wave permeability was evaluated according to the following evaluation standard. It can be said that the smaller the radio wave attenuation rate is, the higher the radio wave permeability is.

Radio wave attenuation rate[dB]=20 × Log₁₀(Ei/Et) Formula 3

In the formula, Ei represents an incident field strength [V/m] and Et represents a conduction field strength [V/m].

<Evaluation Standard>

A: At any frequency, the radio wave attenuation rate is less than 1 dB.

B: At any one frequency, the radio wave attenuation rate is 1 dB or more and less than 10 dB.

C: At any one frequency, the radio wave attenuation rate is 10 dB or more.

6. Heat Transfer Coefficient and Light resistance (ΔU)

(1) A pressure-sensitive adhesive (PD-S1 manufactured by PANAC Co., Ltd.) was applied to a surface of the support of each heat insulation film (the surface on a side not having the silver nanowire-containing layer and the protective layer) to form a pressure sensitive adhesive layer, and each heat insulation film was attached to blue plate glass having a thickness of 3 mm via a pressure sensitive adhesive layer. In this state, measurements were carried out with an infrared spectrometer (IFS 66v/S, manufactured by Bruker Optics) in a wavelength range of 5 μm to 25 μm, and a heat transfer coefficient (W/m²·K) A before a light resistance test was calculated in accordance with JIS A 5759:2008.

(2) Next, while keeping the state of the heat insulation film having the pressure sensitive adhesive layer being attached to the soda-lime glass, light irradiation was performed under conditions of 90 W for 120 hours and under environmental conditions of a temperature of 63° C. and relative humidity of 50% by using a light resistance tester (manufactured by IWASAKI ELECTRIC CO., LTD., trade name: EYESUPER SUV-W161). Thereafter, the heat insulation film after the light irradiation was again measured in a wavelength range of 5 μm to 25 μm with the infrared spectrometer (IFS 66v/S, manufactured by Bruker Optics) and a heat transfer coefficient (W/m²·K) B before a light resistance test was calculated in accordance with JIS A 5759:2008.

(3) Using the above calculated values, a degree of reduction (ΔU) of the heat transfer coefficient was obtained by substracting the heat transfer coefficient A from the heat transfer coefficient B, and was evaluated according to the following evaluation standard. Among evaluation standard, rank 3 or more is a practically acceptable range.

<Evaluation Standard>

5: Δ heat transfer coefficient is less than 0.1.

4: Δ heat transfer coefficient is 0.1 or more and less than 0.2.

3: Δ heat transfer coefficient is 0.2 or more and less than 0.25.

2: Δ heat transfer coefficient is 0.25 or more and less than 0.35.

1: Δ heat transfer coefficient is 0.35 or more.

7. Surface Electrical Resistance

The surface electrical resistance of the surface of the protective layer of the heat insulation film was measured using an eddy current method resistance measurement (manufactured by Napson Corporation, trade name: EC-80).

8. Scratch Resistance

Using a continuous weight type scratch resistance strength tester (manufactured by Shinto Scientific Co., Ltd., trade name: Heidon 18S), a scratch test was performed on the protective layer side of the heat insulation film under the following conditions, and the presence or absence of scratches on the surface (abrasion surface) of the protective layer of the heat insulation film was visually observed and evaluated by using steel wool (NIHON STEEL WOOL Co., Ltd., trade name: BONSTAR No. 0000).

<Standard>

Load: 500 g

Number of times: 10 round trips

Speed: 1000 mm/min

Rubbing length: 50 mm

<Evaluation Standard>

A: No scratch

B: Scratches present

9. Curl

A heat insulation film was cut to a size of 50 cm×50 cm to prepare a sample piece, the sample piece was placed on a desk so that the protective layer faces an anti-gravity direction, a height of which four end portions of the sample piece were lifted off from the desk surface was measured, and a maximum value of the four heights was used as an index for evaluating curl.

<Evaluation Standard>

A: maximum value of height is less than 1 mm.

B: maximum value of height is 1 mm or more and less than 2 mm.

C: maximum value of the height is 2 mm or more.

10. Adhesiveness

A lattice-like notch cut was made on the surface of the protective layer of the heat insulation film with a cutter to form a square of 100 (10×10 (one size: 1 mm×1 mm)), and tape was attached to the surface of the protective layer on which the cut was made (manufactured by NICHIBAN CO., LTD., trade name: CELLOTAPE (registered trademark) 405). Thereafter, the attached tape was peeled off in a direction perpendicular to the surface of the protective layer, the number of peeled squares from the protective layer was counted, and the adhesiveness was evaluated according to the following evaluation standard.

<Evaluation Standard>

A: The number of peeled squares is 0.

B: The number of peeled squares is 1 to 50.

C: The number of peeled squares is 51 to 100.

TABLE 1

| | Silver nanowire-containing layer | | | | | | | | | | | | | | |
|---|---|---|---|---|---|---|---|---|---|---|---|---|---|---|---|
| | | Binder | | | | Average | | | Evaluation | | | | | | |
| | Silver | | | Absorption rate | Swelling | length | | | Light | Heat transfer | | Radio | | | |
| | nanowire | | | (%; 63° C., | ratio of | of silver | Protective layer | | resis- | coefficient | | wave | Surface | | |
| | aqueous | | | 50% RH, 24 h) | thickness | nanowire | | Thickness | tance | (U value) | Scratch | perme- | resistance | | Adhe- |
| | dispersion | Type | Name and the like | [%] | [%] | [μm] | Type | [μm] | (ΔU) | [W/m² · K] | resistance | ability | [Ω/square] | Curl | siveness |
| Example 1 | (1) | Polyolefin | VESTPLAST W1750 | 1 | 1.3 | 5 | Sol-gel | 1 | 4 | 4.7 | A | A | 3000 or more | A | B |
| Example 2 | (1) | PVDC | SARAN LATEX L549B | 0.5 | 1.1 | 5 | Sol-gel | 1 | 4 | 4.7 | A | A | 3000 or more | A | A |
| Example 3 | (1) | PVDC | SARAN LATEX L536B | 1 | 1.3 | 5 | Sol-gel | 1 | 4 | 4.7 | A | A | 3000 or more | A | A |
| Example 4 | (1) | PVDC | SARAN LATEX L509B | 5 | 1.8 | 5 | Sol-gel | 1 | 3 | 4.7 | A | A | 3000 or more | A | A |
| Example 5 | (1) | Polyacrylic | AS-563A | 1 | 1.3 | 5 | Sol-gel | 1 | 5 | 4.7 | A | A | 3000 or more | A | A |
| Example 6 | (1) | Polyacrylic | UX110 | 5 | 1.8 | 5 | Sol-gel | 1 | 4 | 4.7 | A | A | 3000 or more | A | A |
| Example 7 | (1) | Polyacrylic | Synthetic product (MMA | 10 | 2.2 | 5 | Sol-gel | 1 | 3 | 4.7 | A | A | 3000 or more | A | A |
| | | | 42.5:nBA 56.8:AAc 0.6) | | | | | | | | | | | | |
| Example 8 | (1) | Polyurethane | SUPERFLEX E4800 | 1 | 1.3 | 5 | Sol-gel | 1 | 5 | 4.7 | A | A | 3000 or more | A | A |
| Example 9 | (1) | Polyurethane | SUPERFLEX 470 | 2 | 1.4 | 5 | Sol-gel | 1 | 5 | 4.7 | A | A | 3000 or more | A | A |
| Example 10 | (1) | Polyurethane | SUPERFLEX 420 | 5 | 1.8 | 5 | Sol-gel | 1 | 4 | 4.7 | A | A | 3000 or more | A | A |
| Example 11 | (1) | Polyurethane | SUPERFLEX 740 | 10 | 2.2 | 5 | Sol-gel | 1 | 3 | 4.7 | A | A | 3000 or more | A | A |
| Comparative | (1) | Polyurethane | SUPERFLEX 800 | 15 | 2.5 | 5 | Sol-gel | 1 | 2 | 4.7 | A | A | 3000 or more | A | A |
| Example 1 | | | | | | | | | | | | | | | |
| Example 12 | (3) | Polyacrylic | AS-563A | 1 | 1.3 | 10 | Sol-gel | 1 | 5 | 4.7 | A | A | 2000 | A | A |
| Example 13 | (4) | Polyacrylic | AS-563A | 1 | 1.3 | 20 | Sol-gel | 1 | 5 | 4.7 | A | A | 1000 | A | A |
| Comparative | (5) | Polyacrylic | AS-563A | 1 | 1.3 | 23 | Sol-gel | 1 | 5 | 4.7 | A | C | 300 | A | A |
| Example 2 | | | | | | | | | | | | | | | |
| Comparative | (2) | Polyacrylic | AS-563A | 1 | 1.3 | 3 | Sol-gel | 1 | 5 | 5.3 | A | A | 3000 or more | A | A |
| Example 3 | | | | | | | | | | | | | | | |
| Comparative | (1) | PVA | POVAL 117 | 30 | 3.1 | 5 | None | 1 | 5 | 4.7 | B | A | 3000 or more | A | A |
| Example 4 | | | | | | | | | | | | | | | |
| Comparative | (1) | PVA | POVAL 117 | 30 | 3.1 | 5 | Sol-gel | 1 | 1 | 4.7 | A | A | 3000 or more | A | A |
| Example 5 | | | | | | | | | | | | | | | |
| Comparative | (1) | PVA | POVAL 117 | 30 | 3.1 | 5 | Acrylate | 1 | 5 | 4.9 | A | A | 3000 or more | A | A |
| Example 6 | | | | | | | | | | | | | | | |
| Comparative | (5) | PVA | POVAL 117 | 30 | 3.1 | 23 | Sol-gel | 1 | 2 | 4.7 | A | C | 300 | A | A |
| Example 7 | | | | | | | | | | | | | | | |
| Comparative | (1) | EVOH | EVAL L171B | 20 | 2.8 | 5 | Acrylate | 1 | 5 | 4.9 | A | A | 3000 or more | A | A |
| Example 8 | | | | | | | | | | | | | | | |
| Comparative | (5) | EVOH | EVAL L171B | 20 | 2.8 | 23 | Sol-gel | 1 | 2 | 4.7 | A | C | 300 | A | A |
| Example 9 | | | | | | | | | | | | | | | |
| Comparative | (1) | EVOH | EVAL L171B | 20 | 2.8 | 5 | Sol-gel | 1 | 2 | 4.7 | A | A | 3000 or more | A | A |
| Example 10 | | | | | | | | | | | | | | | |
| Example 14 | (1) | Polyacrylic | AS-563A | 1 | 1.3 | 5 | Sol-gel | 0.1 | 5 | 4.7 | A | A | 3000 or more | A | A |
| Example 15 | (1) | Polyacrylic | AS-563A | 1 | 1.3 | 5 | Sol-gel | 5 | 5 | 4.7 | A | A | 3000 or more | A | A |
| Example 16 | (1) | Polyacrylic | AS-563A | 1 | 1.3 | 5 | Sol-gel | 6 | 5 | 4.7 | A | A | 3000 or more | B | A |

* PVDC: polyvinylidene chloride
PVA: polyvinyl alcohol aqueous solution
EVOH: eval solution

Details of the binder shown in Table 1 are as follows.

SARAN LATEX L549B: manufactured by Asahi Kasei Corporation

SARAN LATEX L536B: manufactured by Asahi Kasei Corporation

SARAN LATEX L509B: manufactured by Asahi Kasei Corporation

AS-563A: manufactured by DAICEL FINECHEM LTD.

UX-110: manufactured by DAICEL FINECHEM LTD.

SUPERFLEX E4800: manufactured by DKS Co. Ltd.

SUPERFLEX 470: manufactured by DKS Co. Ltd.

SUPERFLEX 420: manufactured by DKS Co. Ltd.

SUPERFLEX 800: manufactured by DKS Co. Ltd.

As shown in Table 1, in Examples 1 to 11, as the water absorption rate becomes lower, the acid component penetrated in a case of forming the protective layer by the sol-gel method becomes harder, which leads to excellent light resistance. On the other hand, in Comparative Example 1 in which the water absorption rate exceeds 10% (that is, the expansion factor of the thickness of the conductive particle-containing layer exceeds 2.2%), the light resistance remarkably deteriorated. In addition, in a case where polyvinylidene chloride, acrylic polymer, or polyurethane was used as the binder of the silver nanowire-containing layer which is the conductive particle-containing layer, the adhesiveness to the protective layer was particularly favorable.

In Comparative Example 2 in which the average length of the silver nanowire was 23 or more, the surface electrical resistance became excessively low and the radio wave permeability was deteriorated compared to the example in which the average length of the silver nanowire was 20 μm or less. On the other hand, in Comparative Example 3 in which the average length of the silver nanowires was less than 5 μm, the heat insulation effect was not obtained.

In addition, as in Comparative Examples 4 to 10, in a case of using POVAL 117 or EVAL having a water absorption rate of more than 10%, the light resistance of the silver nanowire-containing layer was significantly lowered. In this case, in a case where the acrylate component was used for the binder of the protective layer, the deterioration of the light resistance was alleviated, but the heat transfer coefficient increased, which leads to the result of a decrease in the heat insulation effect.

In a case where the thickness of the protective layer was changed as in Examples 14 to 16, the occurrence of curling was suppressed to be a small value in the range of 0.1 μm to 6 μm, and the workability at the time of the attachment to the window was also favorable. Among these, in the range of 0.1 μm to 5 μm, the effect of suppressing the occurrence of curling was excellent.

### Examples 17 to 32

The heat ray reflective materials produced in Examples 1 to 16 was attached on the surface of the window glass of a building in the following manner, and a window on which the heat ray reflective materials were disposed was produced.

PANACLEAN PS-S1 (manufactured by PANAC Co., Ltd.) was previously attached to the surface of the PET substrate of each heat ray reflective material (the surface not having the protective layer) to form a pressure sensitive adhesive layer.

Subsequently, at the time of attaching the heat ray reflective material to the window glass, 0.1% by mass aqueous solution of a surfactant (sodium polyoxyethylene lauryl ether sulfate) was sprayed to the surface of the window glass and the surface of the pressure sensitive adhesive layer of the heat ray reflective material in advance, the surface of the pressure sensitive adhesive layer of the heat ray reflective material was brought into contact with the sprayed surface of the window glass, and the heat ray reflective material was disposed on the window glass via the pressure sensitive adhesive layer. A position of the heat ray reflective material was adjusted on the glass surface until the moisture evaporated. After the attachment position of the heat ray reflective material on the window glass was determined, the surface of the protective layer of the heat ray reflective material was rubbed with a squeegee or the like, the moisture remaining between the window glass and the heat ray reflective material was swept off from the center of the glass to the end portion, and the heat ray reflective material was fixed to the surface of the window glass.

In this manner, a window in which the heat ray reflective material was disposed was obtained.

In every window on which the heat ray reflective material was disposed, the heat ray reflective material of the present disclosure was used, and therefore the windows have excellent heat insulation property and excellent light resistance, scratch resistance, and radio wave permeability.

The disclosure of JP2015-152757A filed on Jul. 31, 2015 is hereby incorporated by reference in its entirety.

All documents, patent applications, and technical standards described in the present specification are hereby incorporated by reference of the present specification in their entirety to the same extent as in a case where each individual document, patent application, and technical standard were specifically and individually indicated to be incorporated herein by reference.

What is claimed is:

1. A heat ray reflective material comprising, on a support in the following order from the support side:
a conductive particle-containing layer that includes fibrous conductive particles having an average length of 5 μm to 20 μm, and a binder, in which an expansion factor of a thickness before and after the passage of time in a case where 24 hours have elapsed under environmental conditions of a temperature of 63° C. and relative humidity of 50%, is 2.2% or less; and
a protective layer that includes a metal oxide derived from a metal alkoxide.

2. The heat ray reflective material according to claim 1,
wherein the binder is at least one selected from polyvinylidene chloride, acrylic polymer, or polyurethane.

3. The heat ray reflective material according to claim 1,
wherein a thickness of the protective layer is 0.1 μm to 5 μm.

4. The heat ray reflective material according to claim 1,
wherein the fibrous conductive particles are fibrous metal particles.

5. The heat ray reflective material according to claim 1,
wherein the metal oxide included in the protective layer is a metal oxide via a metal hydroxide derived from a metal alkoxide and an acid component.

6. The heat ray reflective material according to claim 1,
wherein the content of the fibrous conductive particles contained in the conductive particle-containing layer is 0.020 g/m² or more and 0.200 g/m² or less.

7. The heat ray reflective material according to claim 1,
wherein a mass ratio of the content of the fibrous conductive particles with respect to the content of the binder is 1/20 or more and 1/3 or less.

8. A window comprising:
a transparent substrate;
a pressure sensitive adhesive layer; and
the heat ray reflective material according to claim 1.

9. A heat ray reflective material comprising, on a support in the following order from the support side:
a conductive particle-containing layer that includes fibrous conductive particles having an average length of 5 μm to 20 μm, and a binder having a water absorption rate of 10% or less; and
a protective layer that includes a metal oxide derived from a metal alkoxide.

10. The heat ray reflective material according to claim 9,
wherein the binder is at least one selected from polyvinylidene chloride, acrylic polymer, or polyurethane.

11. The heat ray reflective material according to claim 9,
wherein a thickness of the protective layer is 0.1 μm to 5 μm.

12. The heat ray reflective material according to claim 9,
wherein the fibrous conductive particles are fibrous metal particles.

13. The heat ray reflective material according to claim 9,
wherein the metal oxide included in the protective layer is a metal oxide via a metal hydroxide derived from a metal alkoxide and an acid component.

14. The heat ray reflective material according to claim 9,
wherein the content of the fibrous conductive particles contained in the conductive particle-containing layer is 0.020 g/m² or more and 0.200 g/m² or less.

15. The heat ray reflective material according to claim 9,
wherein a mass ratio of the content of the fibrous conductive particles with respect to the content of the binder is 1/20 or more and 1/3 or less.

16. A window comprising:
a transparent substrate;
a pressure sensitive adhesive layer; and
the heat ray reflective material according to claim 9.

17. A method for manufacturing a heat ray reflective material, comprising:
applying, on a support, a solution containing fibrous conductive particles having an average length of 5 μm to 20 μm, and a binder having a water absorption rate of 10% or less so as to form a conductive particle-containing layer;
adding a metal alkoxide to an acidic aqueous solution and hydrolyzing the metal alkoxide so as to prepare an aqueous composition containing a metal hydroxide; and
applying the prepared aqueous composition on the conductive particle-containing layer formed on the support and drying the composition so as to form a protective layer including a metal oxide.
